(19) United States
(12) Patent Application Publication
(10) Pub. No.: US 2011/0030815 A1
(43) Pub. Date: Feb. 10, 2011

(54) FLUID MIXING SYSTEM

(75) Inventors: Toshihiro Hanada, Nobeoka-shi (JP); Kenro Yoshino, Nobeoka-shi (JP)

Correspondence Address: BUCHANAN, INGERSOLL & ROONEY PC, POST OFFICE BOX 1404, ALEXANDRIA, VA, 22313-1404, US

(73) Assignee: ASAHI ORGANIC CHEMICALS INDUSTRY CO., LTD., Nobeoka-shi (JP)

(21) Appl. No.: 12/900,054

(22) Filed: Oct. 7, 2010

Related U.S. Application Data
(62) Division of application No. 11/646,570, filed on Dec. 28, 2006.

(30) Foreign Application Priority Data
Mar. 1, 2006 (JP) 2006-055061

(51) Int. Cl. F16K 31/02

(52) U.S. Cl. 137/487.5

(57) ABSTRACT

An object of the present invention is to provide a fluid mixing system able to mix the fluids of different lines by any ratio and control the flow rates of even pulsating fluids, able to control the flow rate of even a pulsating fluid, compact in configuration and able to be installed in a narrow space, and enabling easy pipe laying and pipe connection at the time of installation.

In the system of the present invention, the feed lines 1, 2 are provided with fluid control valves 4, 10 controlling pressures of fluids by pressure operations of control fluids, flow rate measuring devices 3, 9 measuring actual flow rates of the fluids, converting the measured values of the actual flow rates to electrical signals, and outputting the same, and control units 5, 11 outputting command signals for controlling the opening areas of the fluid control valves to the fluid control valves or equipment operating the fluid control valves based on the errors between the measured values of the actual flow rates and flow rate settings. In the system of the present invention, for example, to obtain a washing solution for semiconductor production, hydrofluoric acid or hydrochloric acid is mixed with pure water by a ratio of 1 part to 10 to 200 parts.

### TECHNICAL FIELD

The present invention relates to a fluid mixing system used for fluid transport pipes in which two or more of lines of fluid are mixed by any ratio. More particularly, it relates to a fluid mixing system able to control the flow rates of different lines of fluids to mix the fluids by any ratio, able to control the flow rates without problem even if pulsating fluids flow, compact in configuration, able to be installed in a narrow space, and enabling easy pipe laying and pipe connection at the time of installation.

### BACKGROUND ART

In the past, as one step in the semiconductor production process, washing water comprised of fluoric acid or another chemical diluted with pure water has been used for etching the wafer surface, i.e., wet etching. It was considered that the concentration of the washing water for this wet etching had to be controlled with a high precision. In recent years, control of the concentration of the washing water by the ratio of the flow rates of the pure water and chemicals has become the mainstream practice. For this, fluid mixing systems controlling the flow rates of the pure water and chemicals with a high precision have been used.

Various fluid mixing systems have been proposed. There are for example the multi-line flow rate control system shown in FIG. 25 and its control method (for example, see Japanese Patent Publication No. (A) 2004-13364). This is a flow rate control system outputting operation signals to a plurality of actuators 602 adjusting the flow rates of a plurality of fluid inflow systems 601 for control so that the flow rate of the merged fluid becomes a target flow rate. This flow rate control system outputs operation signals to the other actuators 602b to 602n of the plurality of actuators 602 minus one so that the flow rate becomes substantially constant and outputs an operation signal to one of the plurality of actuators 602 so that the merged fluid flow rate becomes the target value.

At this time, there was a flow rate control system controlling the flow rate of the merged fluid from the plurality of independent fluid inflow systems 601, provided with a processing means 603 for feedback processing from the error between the total value of the detected flow rates of the fluid inflow systems 601 and the target value and outputting an adjustment signal and a control system judging means 604 for selecting one of the fluid inflow systems 601 when the adjustment signal of the processing means 603 became an upper limit or lower limit value, switching from the other actuators 602b to 602n to the actuator 602a of the selected single system, and outputting the adjustment signal as the operation signal.

However, the conventional multi-line flow rate control system and control method used the total of the flow rates of the fluid inflow systems 601 as the target flow rate. The individual fluid inflow systems 601 were not independently controlled, so control was not possible to mix any two or more fluids by any ratio. Further, when pulsating fluids flowed through the fluid inflow systems 601, there was the problem that stable fluid control was no longer possible. Further, the range of flow rates covered could not be made that large in this configuration, so there was the problem that the system was difficult to use for applications controlling a wide range of flow rates. Further, since the control system had a large number of components, the control system itself became large and there was the problem of installation space. Further, since the components were provided for each line, pipe connecting work, electrical work, and air piping work were necessary for each. The work was complicated and took time and the piping laying and cable laying work were troublesome, so there was the problem of a likelihood of error.

### DISCLOSURE OF THE INVENTION

The present invention was made in consideration of the above problems in the prior art and has as its object the provision of a fluid mixing system able to control the flow rates of different lines of fluids to mix the fluids by any ratio, able to control the flow rates without problem even if pulsating fluids flow, compact in configuration, able to be installed in a narrow space, and enabling easy pipe laying and pipe connection at the time of installation.

Explaining the configuration of the fluid mixing system of the present invention for solving the above problem, there is provided a fluid mixing system mixing fluids flowing through at least two feed lines 1, 2 by any ratio, having as its first characteristic that the feed lines 1, 2 are provided with fluid control valves 4, 10 controlling pressures of fluids by pressure operations of control fluids, flow rate measuring devices 3, 9 measuring actual flow rates of the fluids, converting the measured values of the actual flow rates to electrical signals, and outputting the same, and control units 5, 11 outputting command signals for controlling the opening areas of the fluid control valves 4, 10 to the fluid control valves 4, 10 or equipment operating the fluid control valves 4, 10 based on the errors between the measured values of the actual flow rates and flow rate settings.

Further, the invention has as its second characteristic that the feed lines 1, 2 are further provided with shutoff valves 18, 22 for opening up or cutting off the flow of fluids.

Further, the invention has as its third characteristic that the feed lines 1, 2 are further provided with throttle valves 32, 37 able to change the opening areas to adjust the flow rates of the fluids.

Further, the invention has as its fourth characteristic that a header 15 of the feed lines 1, 2 is provided at downstream-most sides of the feed lines 1, 2.

Further, the invention has as its fifth characteristic that the feed lines 1, 2 are provided with the shutoff valves 40, 41 right before the header 15.

Further, the invention has as its sixth characteristic that the header 15 is a manifold valve 42 making the feed lines 1, 2 merge into a single channel.

Further, the invention has as its seventh characteristic that it is further provided with a flushing system 43 provided with a main line provided with a shutoff valve 535a connected to an upstream-most side of any single feed line among the feed lines 1, 2 and at least one other line provided with a shutoff valve 536a connected to the upstream-most sides of the other feed lines, the upstream side of the shutoff valve 535a of the main line and the downstream side of the shutoff valve 536a of the other line communicated through a shutoff valve 537a.

Further, the invention has as its eighth characteristic that the various valves and the flow rate measuring device are directly connected without using any independent connecting means.

Further, the invention has as its ninth characteristic that the various valves and the flow rate measuring device are provided on a single base block.

Further, the invention has as its 10th characteristic that the various valves and the flow rate measuring device are provided housed in a single casing.

Further, the invention has as its 11th characteristic that the each of the fluid control valves 4, 10 is comprised of a body 201 having a second cavity 209 provided at its bottom center opening to the bottom, an inlet channel 211 communicated with the second cavity 209, a first cavity 210 provided at its top opened to the top surface and having a diameter larger than the diameter of the second cavity 209, an outlet channel 212 communicated with the first cavity 210, and a communication hole 213 communicating the first cavity 210 and second cavity 209 and having a smaller diameter than the diameter of the first cavity 210, the top surface of the second cavity 209 made the valve seat 214; a bonnet 202 having inside it a cylindrical cavity 215 communicating with an air feed hole 217 and exhaust hole 218 provided at the side surface or top surface and provided with a step 216 at the inner circumference of its bottom end; a spring holder 203 inserted into the step 216 of the bonnet 202 and having a through hole 291 at its center; a piston 204 having a first connector 224 of a diameter smaller than the through hole 219 of the spring holder 203 at its bottom end, provided with a flange 222 at its top, and inserted into the cavity 215 of the bonnet 202 to be able to move up and down; a spring 205 supported clamped between the bottom end face of the flange 222 of the piston 204 and the top end face of the spring holder 203; a first valve mechanism 206 having a first diaphragm 227 with a peripheral edge fastened clamped between the body 201 and the spring holder 203 and with a thick center forming a first valve chamber 231 in a manner capping the first cavity 210 of the body 201, a second connector 229 at the center of the top surface fastened joined to the first connector 224 of the piston 204 through the through hole 219 of the spring holder 203, and a third connector 230 at the center of the bottom surface passing through the communication hole 213 of the body 201; a second valve mechanism 207 having a valve element 232 positioned inside the second cavity 209 of the body and provided in a larger diameter than the communication hole 213 of the body, a fourth connector 234 provided projecting out from the top end face of the valve element 232 and fastened joined to the third connector 230 of the first valve mechanism 206, a rod 235 provided projecting out from the bottom end face of the valve element 232, and a second diaphragm 237 provided extending out from the bottom end face of the rod 235 in the radial direction; and a base plate 208 positioned below the body 201, having at the center of its top a projection 239 for fastening the peripheral edge of the second diaphragm 237 of the second valve mechanism 207 by clamping it with the body 201, provided with an inset recess 240 at the top end of the projection 239, and provided with a breathing hole 241 communicating with the inset recess 240; the opening area of the fluid control part 242 formed by the valve element 232 of the second valve mechanism 207 and the valve seat 214 of the body 201 changing along with up and down movement of the piston 204.

Further, the invention has as its 13th characteristic that the each of the fluid control valves 4, 10 has a body 121 formed from an inlet channel 145 and outlet channel 152 of the fluid and a chamber 127 communicating the inlet channel 145 and outlet channel 152, a valve member 136 having a valve element 165 and first diaphragm 137, and a second diaphragm 138 and third diaphragm 139 positioned at the bottom and top of the valve member 136 and having an effective pressure receiving area smaller than the first diaphragm 137; the valve member 136 and the diaphragms 137, 138, 139 are attached in the chamber 127 by the outer circumferences of the diaphragms 137, 138, 139 being fastened to the body 121; the diaphragms 137, 138, 139 divide the chamber 127 into a first pressurized chamber 128, second valve chamber 129, first valve chamber 130, and second pressurized chamber 131; the first pressurized chamber 128 has a means for applying a certain force in an inward direction to the second diaphragm 138 at all times; the first valve chamber 130 is communicated with the inlet channel 145; the second valve chamber 129 has a fluid control part 168 having a valve seat 150 corresponding to the valve element 165 of the valve member 136, formed divided into a bottom second valve chamber 132 positioned at the first diaphragm 137 side from the valve seat 150 and communicated with the first valve chamber 130 by a communication hole 162 provided in the first diaphragm 137 and a top second valve chamber 133 positioned at the second diaphragm 138 side and communicated with the outlet channel 152, and changing in opening area between the valve element 165 and valve seat 150 by up and down movement of the valve member 136 to control the fluid pressure of the bottom second valve chamber 134; and the second pressurized chamber 131 has a means for applying a certain force in the inward direction to the third diaphragm 139 at all times.

Further, the invention has as its 13th characteristic that each of said throttle valves 32, 37 is provided with a body 251 formed with a valve seat surface 252 at the bottom surface of the valve chamber 253 provided at the top and having an inlet channel 255 communicating with a communication port 254 provided at the center of the valve seat surface 252 and an outlet channel 256 communicating with the valve chamber 253; a diaphragm 260 integrally provided with a first valve element 261 able to be inserted into the communication port 254 by advancing and retracting movement in the axial direction of the stem and projecting hanging down from the center of the liquid contacting surface, a ring-shaped projecting second valve element 262 able to approach and separate from the valve seat surface 252 and formed at a position away from the first valve element 261 in the radial direction, and a thin film part 263 formed continuing in the radial direction from the second valve element 262; a first stem 277 having a handle 54 fastened to its top and having a female thread 278 at its bottom inner circumference and a male thread 279 having a pitch larger than the pitch of the female thread 278 at its outer circumference; a first stem support 282 having a female thread 283 screwed with the male thread 279 of the first stem 277 at its inner circumference; a second stem 269 having a male thread 270 screwed with the female thread 278 of the first stem 277 at the outer circumference of its top and connected to the diaphragm 260 at its bottom end; a diaphragm holder 271 positioned below the first stem support 282 and supporting the second stem 269 to be able to move up and down and rotate; and a bonnet 286 fastening the first stem 277 and diaphragm holder 271.

Further, the invention has as its 14th characteristic that the flow rate measuring device is an ultrasonic flow meter, Karman vortex flow meter, ultrasonic vortex flow meter, bladed wheel flow meter, electromagnetic flow meter, differential pressure flow meter, volume flow meter, hot wire type flow meter, or mass flow meter.

Further, the invention has as its 15th characteristic that two types of fluid comprising hydrofluoric acid or hydrochloric acid and pure water are mixed in a ratio of hydrofluoric acid or hydrochloric acid and pure water of 1:10 to 200.

Further, the invention has as its 16th characteristic that three types of fluid comprised of ammonia water or hydrochloric acid, hydrogen peroxide, and pure water are mixed in a ratio of ammonia water or hydrochloric acid, hydrogen peroxide, and pure water of 1 to 3:1 to 5:10 to 200.

Further, the invention has as its 17th characteristic that three types of fluid comprised of hydrofluoric acid, ammonium fluoride, and pure water are mixed in a ratio of hydrofluoric acid, ammonium fluoride, and pure water of 1:7 to 10:50 to 100.

In the present invention, the fluid control valves 4, 10 are not particularly limited so long as they can control the pressures by changing the operating pressures of the control fluids, but a configuration as shown in FIG. 3 having the fluid control valves 4, 10 of the present invention controlling the pressures of the fluids or as shown in FIG. 22 having the fluid control valves 4a of the present invention for controlling the flow rates of the fluids is preferable. Note that the “control fluids” means for example working air, working oil, etc. This is suitable since it enables stable fluid control, enables stabilization of the pressures or flow rates to constant pressures by the fluid control valves 4, 10, 4a even if pulsating fluids are flowing, enables the channels to be shut by just the fluid control valves 4, 10, 4a, is compact in configuration, and enables provision of a small fluid mixing system.

Further, in the present invention, as shown in FIG. 4, can provide shutoff valves 18, 22 in the feed lines 16, 17 of the fluid mixing system. This is preferable in that provision of the shutoff valves 18, 22 facilitates maintenance etc. (repair and part replacement) of the fluid mixing system by shutting off the shutoff valves 18, 22. Further, if providing the fluid mixing system with the shutoff valves 18, 22, when shutting off the channels and disassembling the fluid mixing system for maintenance etc., the leakage of the fluid remaining in the channels from the disassembled parts can be kept to a minimum. Further, when some sort of trouble occurs in the channels, the shutoff valves 18, 22 enable the flow of fluid to be shut off on an emergency basis.

Further, the shutoff valves 18, 22 are not particularly limited in configuration so long as they have the function of opening and cutting off the flow of fluid. They may be manually operated ones or air driven, electrically driven, magnetically driven, or other automatic ones. In the automatic case, it is possible to provide a control circuit, link it up with the flow rate measuring devices 19, 23, and drive the shutoff valves 18, 22 in accordance with the measured values or possible to drive them independently from the fluid mixing system. When driving them linked with the fluid mixing system, overall control in the fluid mixing system is possible. When driving them independently from the fluid mixing system, when trouble occurs in the fluid mixing system and the shutoff valves 18, 22 are used to shut off the channels on an emergency basis, they can be driven without being affected by the trouble in the fluid mixing system.

Further, the shutoff valves 18, 22 are preferably positioned at the upstream side from the other valves and flow rate measuring devices for maintenance etc. Further, the shutoff valves 18, 22 may be provided at any of lines of the feed lines 16, 17 or may be provided at all of the lines.

The throttle valves 32, 37 of the present invention are not particularly limited so long as they are configured to be able to adjust the opening areas and narrow the channel to stabilize the flow rates, but ones having the configuration shown in FIG. 7 of the throttle valves 32, 37 of the present invention are preferable. This is suitable since it enables control of the flow rates in a broad range of flow rate, enables the opening degrees of the throttle valves 32, 37 to be easily and precisely finely controlled, so enables the opening degrees to be finely adjusted in a short time, is compact in configuration without taking up space in the height direction, and can provide the fluid mixing system small.

Further, in FIG. 7, the pitch difference between the male thread 279 provided at the outer circumference of the first stem 277 of each of the throttle valve 32, 37 and the female thread 278 provided at the inner circumference of the bottom is formed to become one-sixth of the pitch of the male thread 279, but the pitch difference is preferably provided in the range from 1/20th to one-fifth of the male thread pitch. The valve element gives a certain range of lift from fully closed to fully opened, so to prevent the stroke of the handle 54 from becoming too large and the valve height from becoming large, the pitch difference should be made larger than 1/20th of the male thread pitch. For good precision adjustment of the valve on a micro order, the pitch difference should be made smaller than one-fifth of the male thread pitch.

Further, in FIG. 8, the outside diameter D1 of the straight part 267 of the first valve element 261 is set to 0.97D of the inside diameter D of the communication port 254, but the outside diameter D1 of the straight part 267 is preferably in the range of 0.95D≦D1≦0.995D with respect to the inside diameter D of the communication port 254. To prevent the first valve element 261 and communication port 254 from sliding contact, D1≦0.995D is suitable. For smoothly adjusting the flow rate, 0.95D≦D1 is suitable.

Further, the taper 268 of the first valve element 261 is set to a taper angle of 15° with respect to the axis, but it is preferable in a range of 12° to 28°. To adjust a broad range of flow rate without increasing the size of the valve, 12° or more is suitable. To prevent the flow rate from quickly changing with respect to the opening degree, 28° or less is suitable. Further, the diameter D2 of the ring-shaped projection of the second valve element 262 is set to 1.5D with respect to the inside diameter D of the communication port 25, but the diameter D2 of the ring-shaped projection of the second valve element 262 is preferably within the range of 1.1D≦D2≦2D with respect to inside diameter D of the communication port 254. To reliably provide a ring-shaped groove 265 between the first valve element 261 and the second valve element 262 and obtain a space part in which the flow of fluid is suppressed, 1.1D≦D2 is suitable. To suppress the rate of increase of the opening area formed between the second valve element 262 and the valve seat surface 252 with respect to the opening degree, D2≦2D is suitable.

In the present invention, the flow rate measuring devices 3, 9 are not particularly limited so long as they can convert the measured flow rates to electrical signals for output to the control units 5, 11. The flow rate measuring devices are preferably ultrasonic flow meters, Karman vortex flow meters, ultrasonic type vortex flow meters, bladed wheel type flow meters, electromagnetic flow meters, differential pressure flow meters, volume type flow meters, hot wire type flow meters, mass flow meters, etc. In particular, in the case of ultrasonic flow meters such as shown in FIG. 2 or FIG. 24, they can measure the flow rates with a good precision even for fine flow rates, so are suitable for fine flow rate fluid control. Further, in the case of the ultrasonic type vortex flow meters shown in FIG. 25, they can measure the flow rates with a good precision even for large flow rates, so are suitable for large flow rate fluid control. In this way, by selectively using ultrasonic flow meters and ultrasonic type vortex flow meters in accordance with the flow rates of the fluids, good precision fluid control becomes possible. Further, in the present embodiment, the control units 5, 11 are individually provided in the feed lines, but they may also be provided concentrated at one location.

Providing a header 15 of the feed lines 1, 2 at the downstream-most sides of the feed lines 1, 2 enables the fluids flowing through the feed lines 1, 2 to be mixed. Further, as shown in FIG. 11, it is preferable to provide shutoff valves 40, 41 at the feed lines 27a, 28b right before the header 39a. This enables feed of fluids of the feed lines 27a, 28a by single feed lines, selection of fluids for mixing from the feed lines 27a, 28a, and outflow by any flow rates. Further, at the time of maintenance etc. of the feed lines 27a, 28a, closing the shutoff valves 40, 41 enables backflow of the fluids to be prevented and the leakage of fluids to be reliably prevented at the time of maintenance etc. Further, as shown in FIG. 12, the header is preferably a manifold valve 42. This gives similar effects to the case of providing shutoff valves 40, 41 in the feed lines 27a, 28a right before the header 39a and enables the fluid mixing system to be formed compact. Further, by providing a plurality of feed lines and operating the shutoff valves 40, 41 or manifold valve 42, it is possible to select fluids from some of the feed lines for mixing and possible to change the settings of the flow rates of the feed lines to freely set the fluids and their mixing ratios. Note that the feed lines 27b, 28b and the manifold valve 42 may be directly connected without using independent connecting means and may be provided at a single base block. This is preferable since it enables the fluid mixing system to be formed more compact. Further, it is possible to provide the valves and the measuring devices downstream from the header 15. The invention is not particularly limited as to this.

Further, as shown in FIG. 14, it is preferable to provide a flushing system 43 of the present invention at the upstream-most sides of the feed lines. This enables the fluid flowing into any single feed line to be used for washing. For example, in FIG. 14, by closing the shutoff valves 535a, 536a of the flushing system 43 and opening the shutoff valve 537a, it is possible to run pure water flowing through the single feed line 27c to the other feed line 28c and possible to flush and wash the other feed line 28c with pure water. Further, the flushing system 43 of the present invention is not particularly limited in configuration so long as uses valves, but it is preferably configured with the valves provided on a single base block where the channels are formed. In particular, as shown in FIG. 15 and FIG. 16, it is preferable to provide drive parts 532, 533, and 534 for driving the operations of the valve elements 550, 551, and 552 at the single base block where the channels are formed, that is, the body 531, at the top and bottom of the base 53. This enables the shutoff valves to be centralized and the flushing system 43 to be provided compactly and further enables the fluid mixing system to be provided compactly.

In the embodiment of the present invention, the case of two feed lines was shown, but it is also possible to provide more than two feed lines, merge two or more feed lines, then merge them with other feed lines, and mix two or more fluids by any ratio in accordance with the number of feed lines. Further, it is also possible to provide a plurality of feed lines and open and close the shutoff valves 40, 41 or the manifold valve 42 provided at the downstream most side of the feed lines to select the fluids to be mixed and possible to freely set the mixing ratio by changing the settings of the flow rates of the feed lines.

In the fluid mixing system of the present invention, as shown in FIG. 17 and FIG. 18, the adjoining valves and flow rate measuring devices are preferably directly connected without using independent connecting means. The “directly connected without using independent connecting means” referred to here has two meanings. One is no use of separate tubes or pipes. This is the method of direct connection of separate members through connection members 46, 47, 48, 49 for channel sealing or channel directional change without provision of tubes or pipes such as shown in FIG. 18. The other is no use of separate joints. This is the method of direct connection of the end faces of members to be connected or the end faces of connectors of those members through seal members. Due to this, the fluid mixing system can be made compact and the space used at the installation site can be reduced, the installation work becomes easier, the work time can be shortened, and the channels in the fluid mixing system can be shortened to the smallest required lengths, so the fluid resistance can be reduced.

The fluid mixing system of the present invention, as shown in FIG. 19 and FIG. 20, preferably provides the valves and flow rate measuring devices at the single base block 51 where the channels are formed. This is because by providing the components at the single base block 51, the fluid mixing system can be made compact and the space used at the installation site can be reduced, the installation work becomes easier, the work time can be shortened, and the channels in the fluid mixing system can be shortened to the smallest required lengths, so the fluid resistance can be reduced, and the number of parts can be reduced, so the fluid mixing system can be easily assembled.

The fluid mixing system of the present invention, as shown in FIG. 21, is preferably configured provided inside a single casing 53. This is preferable since by providing it in a single casing 53, the fluid mixing system becomes a single module, so installation becomes easy and the work time in the installation work can be shortened. Further, the casing 53 protects the valves and the flow rate measuring devices and makes the fluid mixing system a “black box”, so when installing a fluid mixing system designed for feedback control such as in the present invention into a semiconductor production system, it is possible to prevent the user of the semiconductor production system from easily disassembling the fluid mixing system and causing some sort of trouble.

Further, the fluid mixing system of the present invention preferably has the handle 54 of the throttle valve 37f exposed at the outside of the casing 53 and enables easy operation of the handle 54 by the operator by hand etc. Further, in accordance with need, it may also be configured with the flow rate measuring devices 3, 9 exposed from the casing 53.

The flow rate measuring devices 3, 9, fluid control valves 4, 10, shutoff valves 18, 22, and throttle valves 32, 37 of the present invention may be provided in any order. The order is not particularly limited, but provision of the throttle valves 32, 37 at the downstream side from the fluid control valves 4, 10 and flow rate measuring devices 3, 9 is preferable since it enables easy stable adjustment of the flow rate.

Further, the fluid mixing system of the present invention may be used for any application where the flow rates of the fluids or two or more feed lines has to be controlled to certain constant values such as chemical and other industrial plants, semiconductor production, the medical field, the foodstuff field, and other various industries, but provision in a semiconductor production system is preferable. As front end steps of the semiconductor production process, the photoresist step, pattern exposure step, etching step, flattening step, etc. may be mentioned. The fluid mixing system of the present invention is preferably used when managing the concentration of the washing water by the ratio of the flow rates of pure water and the chemicals.

Further, regarding the fluids mixed by the fluid mixing system of the present invention and their ratio, the invention preferably provides a fluid mixing system having at least two feed lines wherein two types of fluid comprised of hydrofluoric acid or hydrochloric acid and pure water are mixed by a ratio of hydrofluoric acid or hydrochloric acid:pure water of 1:10 to 200. Further, it preferably provides a fluid mixing system having at least three feed lines wherein three types of fluids comprised of ammonia water or hydrochloric acid, hydrogen peroxide, and pure water are mixed by a ratio of ammonia water or hydrochloric acid, hydrogen peroxide, and pure water of 1 to 3:1 to 5:10 to 200 or wherein three types of fluids comprised of hydrofluoric acid, ammonium fluoride, and pure water are mixed by a ratio of hydrofluoric acid, ammonium fluoride, and pure water of 1:7 to 10:50 to 100. The mixed fluids obtained by mixing these fluids by the above ratios are suitably used as chemicals for surface treatment of substrates in front-end steps of the semiconductor production process.

The mixed fluid of hydrofluoric acid and pure water and the mixed fluid of hydrochloric acid and pure water are suitable as chemicals used for removing natural oxide films, removing ordinary oxide films, or removing metals (metal ions) in surface treatment of substrates. The ratio of pure water to hydrofluoric acid or hydrochloric acid is preferably 10 or more to 1 since a higher concentration of chemicals suppresses unevenness at the substrate. To prevent a drop in the effect of treatment for removing oxides or removing metals due to the lower concentration of chemicals, the ratio is preferably not more than 200 to 1. Note that these mixed fluids can be effectively used at fluid temperatures of 20° C. to 25° C.

The mixed fluid of ammonia water, hydrogen peroxide, and pure water is suitable as a chemical used for removing foreign matter (particles) during surface treatment of substrates, while the mixed fluid of hydrochloric acid, hydrogen peroxide, and pure water is suitable as a chemical used for removal of metals. The ratio of the hydrogen peroxide to the ammonia water or hydrochloric acid is preferably in the range of 1 to 5:1 to 3 to enable effective removal of foreign matter or removal of metal. The ratio of pure water to ammonia water or hydrochloric acid is preferably 10 or more:1 to 3 since raising the concentration of the chemicals enables the occurrence of unevenness or surface roughness at the substrates to be suppressed and is preferably 200 or less:1 to 3 to prevent a drop in the effect of treatment for removing foreign matter or removing metals due to the lower concentration of chemicals. Note that this mixed fluid can be effectively used at a fluid temperature of 25° C. to 80° C. and can be more effectively used at a fluid temperature of 60° C. to 70° C.

The mixed fluid of hydrofluoric acid, ammonium fluoride, and pure water is suitable for etching oxide films in the surface treatment of substrates. The ratio of the ammonium fluoride to hydrofluoric acid is preferably in the range of 7 to 10:1 for effective etching of oxide films. The ratio of pure water to hydrofluoric acid is preferably 50 or more:1 since a higher concentration of chemicals suppresses unevenness or surface roughness at the substrate. To prevent a drop in the effect of treatment for etching the oxide films due to the lower concentration of chemicals, the ratio is preferably not more than 100 to 1. Note that this mixed fluid can be effectively used at a fluid temperature of 20° C. to 25° C.

Further, the fluid mixing system of the present invention may be provided with a plurality of feed lines carrying the same fluid. For example, there may be a fluid mixing system comprised of a single feed line carrying pure water and two feed lines carrying hydrochloric acid. By selecting between a case of feeding hydrochloric acid through a single feed line and the case of feeding it through two feed lines, it is possible to set the flow rate of the hydrochloric acid over a broader range and therefore possible to set the mixing ratio of the pure water and hydrochloric acid mixed at the fluid mixing system over a broader range.

Further, the parts of the flow rate measuring devices 3, 9, fluid control valve 4, 10, shutoff valves 18, 22, and throttle valves 32, 37 of the present invention should be made of particularly polytetrafluoroethylene (hereinafter referred to as “PTFE”), polyvinylidene fluoride (hereinafter referred to as “PVDF”), tetrafluoroethylene-perfluoroalkylvinyl ether copolymer resins (hereinafter referred to as “PFA”), and other fluororesins at the parts forming the channels in contact with the fluids. They can be used without problem even if carrying hydrofluoric acid, hydrochloric acid, hydrogen peroxide, ammonia water, and ammonium fluoride at a fluid temperature of a range of 20° C. to 80° C. Even if carrying corrosive fluids and permeated by corrosive gases, the system can be used without concern over corrosion of the valves and flow rate measuring devices. As other materials, polypropylene (hereinafter referred to as “PP”), polyethylene (hereinafter referred to as “PE”), polyvinyl chloride resin (hereinafter referred to as “PVC”), etc. may be mentioned. PP can be used without problem even if carrying hydrofluoric acid, hydrochloric acid, ammonia water, or ammonium fluoride at a fluid temperature of a range of 20° C. to 80° C., PE can be used without problem even if carrying hydrofluoric acid, hydrochloric acid, hydrogen peroxide, ammonia water, or ammonium fluoride at a fluid temperature of a range of 20° C. to 60° C., and PVC can be used without problem even if carrying hydrochloric acid or ammonia water at a fluid temperature of a range of 20° C. to 60° C. and even if carrying hydrofluoric acid, hydrogen peroxide, or ammonium fluoride at a fluid temperature of a range of 20° C. to 25° C. The parts not contacting the fluids are not particularly limited in material so long as they have the required strength. Further, the springs 205 used in the fluid control valves 4, 10 do not contact the fluids, but when carrying corrosive fluids, coating them by a fluororesin prevents corrosion when a corrosive gas permeates the system.

The present invention uses the above structure and gives the following superior effects: (1) By feedback control of each of the feed lines of the fluid mixing system, the actual flow rate of fluid at each of the feed lines can be stabilized at the set flow rate with a good response and the fluids can be mixed by the set ratio. Further, the fluids can be mixed at any ratio automatically by changing the flow rate settings. (2) If using a fluid control valve of the present invention for a feed line, the pressure or flow rate can be stabilized at the constant pressure by the fluid control valve even if a pulsating fluid flows and, since the valves are compactly configured, the fluid mixing system can be provided smaller. (3) If providing shutoff valves at the feed lines, the shutoff valves can be closed to enable easy maintenance etc. of the fluid mixing system without leakage of fluids. Further, when some sort of trouble occurs in the channels, the shutoff valves can be used to shut off the flows of fluids on an emergency basis. (4) If using the throttle valve of the present invention in the fluid mixing system, the flow rate can be adjusted over a broad range of flow rate and, since a throttle valve can be easily and precisely adjusted in opening degree finely, fine adjustment of the flow rate in a short time can be performed and the valve can be structured compactly without taking up space in the height direction and the fluid mixing system can be set small. (5) By providing shutoff valves at the feed lines right before the header, fluid can be fed by individual feed lines or fluids can be mixed from selected feed lines. Further, by providing a manifold valve at the header, the fluid mixing system can be formed compact. (6) By providing a flushing system at the upstream-most sides of the feed lines, the flushing system may be operated to flush other feed lines with the fluid flowing through a first feed line and thereby enable easy cleaning. (7) By directly connecting the various valves and flow rate measuring devices of the fluid mixing system, the fluid mixing system can be made more compact, the space used at the installation site can be reduced, the installation work becomes easy, the work time can be shortened, the channels in the fluid mixing system can be shortened to their shortest necessary lengths, and the fluid resistance can be suppressed. (8) If providing the fluid mixing system at a single base block in which the channels are formed, the fluid mixing system can be made compact, the space used at the installation site can be reduced, the installation work becomes easy, the work time can be shortened, the number of parts are smaller, so assembly of the fluid mixing system can be made easier, the channels in the fluid mixing system can be shortened to their shortest necessary lengths, and the fluid resistance can be suppressed. (9) By providing the fluid mixing system in a single casing, the work time of the installation work can be shortened, the valves and the flow rate measuring devices are protected by the casing, and the fluid mixing system is made a “black box”, so unknowledgeable users can be prevented from disassembling the fluid mixing system and therefore trouble due to disassembly can be prevented.

Below, the present invention will be able to be more sufficiently understood from the attached drawings and the description of the preferred embodiments.

### BRIEF DESCRIPTION OF THE DRAWINGS

FIG. 1 is a view of the configuration schematically showing a first embodiment of the fluid mixing system of the present invention.

FIG. 2 is a vertical cross-sectional view of a flow rate measuring device.

FIG. 3 is a vertical cross-sectional view of a fluid control valve.

FIG. 4 is a view of the configuration schematically showing a second embodiment of the fluid mixing system of the present invention.

FIG. 5 is a vertical cross-sectional view of a shutoff valve.

FIG. 6 is a view of the configuration schematically showing a third embodiment of the fluid mixing system of the present invention.

FIG. 7 is a vertical cross-sectional view of a throttle valve.

FIG. 8 is an enlarged view of principal parts showing the state where the throttle valve of FIG. 7 is in the open state.

FIG. 9 is an enlarged view of principal parts showing the state where the throttle valve of FIG. 7 is the closed state.

FIG. 10 is an enlarged view of principal parts showing the state where the throttle valve of FIG. 7 is in the half open state.

FIG. 11 is a view of the configuration schematically showing a fourth embodiment of the fluid mixing system of the present invention.

FIG. 12 is a view of the configuration schematically showing a fifth embodiment of the fluid mixing system of the present invention.

FIG. 13 is a vertical cross-sectional view of a manifold valve.

FIG. 14 is a view of the configuration schematically showing a sixth embodiment of the fluid mixing system of the present invention.

FIG. 15 is a perspective view schematically showing the channels of the flushing system of the present invention.

FIG. 16 is a vertical cross-sectional view along the line A-A of FIG. 15.

FIG. 17 is a plan view schematically showing a seventh embodiment of the fluid mixing system of the present invention.

FIG. 18 is a cross-sectional view along the line B-B of FIG. 17.

FIG. 19 is a plan view schematically showing an eighth embodiment of the fluid mixing system of the present invention.

FIG. 20 is a cross-sectional view along the line C-C of FIG. 19.

FIG. 21 is a cross-sectional view schematically showing a ninth embodiment of the fluid mixing system of the present invention.

FIG. 22 is a vertical cross-sectional view of another fluid control valve of a 10th embodiment of the fluid mixing system of the present invention.

FIG. 23 is the same view as FIG. 23 adding other indications to FIG. 22.

FIG. 24 is a vertical cross-sectional view of another fluid control valve of an 11th embodiment of the fluid mixing system of the present invention.

FIG. 25 is a vertical cross-sectional view of another fluid control valve of a 12th embodiment of the fluid mixing system of the present invention.

FIG. 26 is a view of the configuration of a conventional flow rate control system.

### BEST MODE FOR CARRYING OUT THE INVENTION

Below, embodiments of the present invention will be explained with reference to the drawings, but the present invention is of course not limited to these embodiments.

### First Embodiment

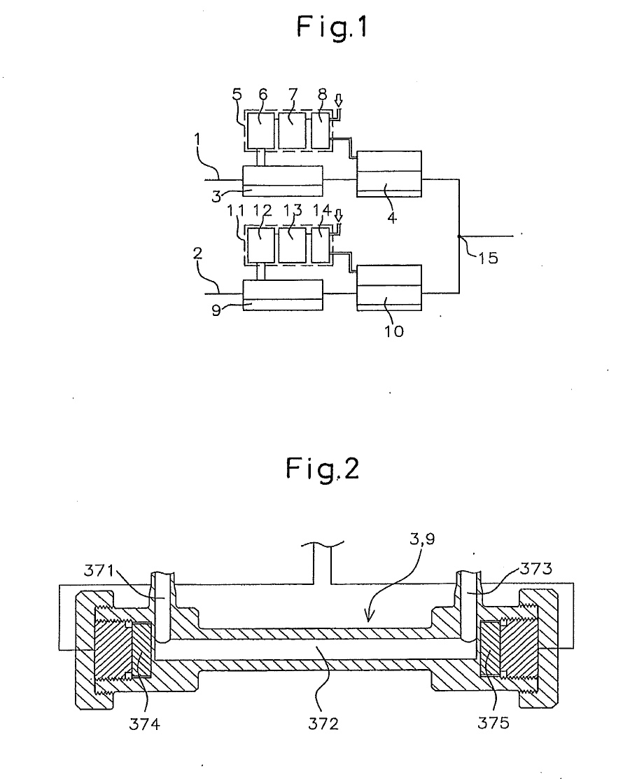

Below, a fluid mixing system of a first embodiment of the present invention will be explained based on FIG. 1 to FIG. 3.

This fluid mixing system is formed from two feed lines, that is, a first feed line 1 and a second feed line 2. The first feed line 1 has a flow rate measuring device 3 and a fluid control valve 4 connected to it in that order and is provided with a control unit 5, while the second feed line 2 has a flow rate measuring device 9 and fluid control valve 10 connected to it in that order and is provided with a control unit 11. At the downstream-most sides of the first and second feed lines 1, 2, a header 15 of the feed lines 1, 2 is provided. The configurations of these components will be explained below.

3, 9 are flow rate measuring devices constituted as ultrasonic flow meters for measuring the flow rates of the fluids. Each of the flow rate measuring devices 3, 9 has an inlet channel 371, a straight channel 372 provided perpendicularly from the inlet channel 371, and an outlet channel 373 provided perpendicularly from the straight channel 372 and provided parallel to the inlet channel 371 in the same direction. At positions of the side walls of the inlet and outlet channels 371, 373 crossing the axis of the straight channel 372, ultrasonic vibrators 374, 375 are arranged facing each other. The ultrasonic vibrators 374, 375 are covered by a fluororesin. The wires extending from the vibrators 374, 375 are connected to processing units 6, 12 of the later explained control units 5, 11. Note that the parts of the flow rate measuring devices 3, 9 other than the ultrasonic vibrators 374, 375 are made of PFA.

4, 10 are fluid control valves for controlling the fluid pressures in accordance with the operating pressures. Each of the fluid control valves 4, 10 is formed by a body 201, bonnet 202, spring holder 203, piston 204, spring 205, first valve mechanism 206, second valve mechanism 207, and base plate 208.

201 is a PTFE body. It has a second cavity 209 opening to the bottom provided at the center of its bottom and a first cavity 210 opening at the top surface provided at the top and having a diameter larger than the diameter of the second cavity 209. It is provided at its side surface with an inlet channel 211 communicated with the second cavity 209, an outlet channel 212 at the surface facing the inlet channel 211 and communicated with the first cavity 210, and a communication hole 213 communicating the first cavity 210 and second cavity 209 and having a diameter smaller than the diameter of the first cavity 210. The top surface of the second cavity 209 is made the valve seat 214.

202 is a PVDF bonnet. It is provided with a cylindrical cavity 215 inside it and a step 216 flared out from the cavity 215 at the inner circumference of the bottom end. It is provided at its side surfaces with an air feed hole 217 communicating the cavity 215 and the outside for feeding compressed air to the inside of the cavity 215 and a fine exhaust hole 218 for exhausting a fine amount of the compressed air introduced from the air feed hole 217. Note that the exhaust hole 218 need not be provided when not necessary for the supply of compressed air.

203 is a PVDF circular planar shape spring holder. It has a through hole 219 in its center and has its approximately top half inserted into the step 216 of the bonnet 202. The side surface of the spring holder 203 is provided with a ring-shaped groove 220. An O-ring 221 is fit into this to prevent compressed air from flowing out from the bonnet 202 to the outside.

204 is a PVDF piston. This has a disk shaped flange 222 at its top, a piston shaft 223 provided projecting out from the center bottom of the flange 222 in a cylindrical shape, and a first connector 223 provided at the bottom end of the piston shaft 223 and comprised of a female thread. The piston shaft 223 is provided with a smaller diameter than the through hole 219 of the spring holder 203. The first connector 224 is screwed together with a second connector 229 of a later explained first valve mechanism 206.

205 is an SUS spring. This is clamped between the bottom end face of the flange 222 of the piston 204 and the top end face of the spring holder 203. The spring 205 expands and contracts along with up and down movement of the piston 204, but one with a long free length is preferably used so that the change of the load at that time is small.

206 is a PTFE first valve mechanism. This has a film part 226 having a tubular part 225 provided projecting upward from an outer peripheral edge, a first diaphragm 227 having a thick part at its center, a second connector 229 comprised of a small diameter male thread provided at the top end of a shaft 228 provided projecting out from the top surface of the center of the first diaphragm 227, and a third connector 230 provided projecting out from the bottom surface of the center of the same, comprised of a female thread formed at its bottom end, and screwed with a fourth connector 234 of a later explained second valve mechanism 207. The tubular part 225 of the first diaphragm 227 is fastened by being clamped between the body 201 and the spring holder 203 whereby a first valve chamber 231 formed by the bottom surface of the first diaphragm 227 is formed sealed. Further, the top surface of the first diaphragm 227 and the cavity 215 of the bonnet 202 are sealed by an O-ring 221, whereby an air chamber filled with compressed air fed from the air feed hole 217 of the bonnet 202 is formed.

207 is a PTFE second valve mechanism. This is comprised of a valve element 232 arranged inside the second cavity 209 of the body 201 and provided in a larger diameter than the communication hole 213, a shaft 233 provided projecting out from the top end face of the valve element 232, a fourth connector 234 comprised of a male thread fastened by screwing together with the third connector 230 provided at the top end, a rod 235 provided projecting out from the bottom end face of the valve element 232, and a second diaphragm 237 having a tubular projection 236 provided extending from the bottom end face of the rod 235 in the radial direction and provided projecting downward from the peripheral edge. The tubular projection 236 of the second diaphragm 237 is clamped between the projection 239 of the later explained base plate 208 and the body 201, whereby a second valve chamber 238 formed by the second cavity 209 of the body 201 and the second diaphragm 237 is sealed.

208 is a PVDF base plate. At the center of its top, it has a projection 239 fastening the tubular projection 236 of the second diaphragm 237 of the second valve mechanism 207 by clamping it with the body 201. The top end part of the projection 239 is provided with an inset recess 240, while the side surface is provided with a breathing hole 241 communicating with the inset recess 240. The base plate is fastened clamped with the bonnet 202 through the body 201 by bolts and nuts (not shown). Note that in the present embodiment, a spring 205 is provided in the cavity 215 of the bonnet 202 to bias the piston 204, first valve mechanism 206, and second valve mechanism 207 upward, but the spring 205 may also be provided in the inset recess 240 of the base plate 208 to bias the piston 204, first valve mechanism 206, and second valve mechanism 207 upward.

5, 11 are control units. The control units 5, 11 have processing units 6, 12 for calculating the flow rates from the signals output from the flow rate measuring devices 3, 9 and controllers 7, 13 for feedback control. Each of the processing units 6, 12 is provided with a transmitting circuit for outputting an ultrasonic vibration of a certain period to the transmitting side ultrasonic vibrator 374, a receiving circuit for receiving ultrasonic vibration from a receiving side ultrasonic vibrator 375, a comparison circuit for comparing the propagation times of the ultrasonic vibrations, and a processing circuit for calculating the flow rate from the difference in propagation times output from the comparison circuit. The controllers 7, 13 have control circuits for controlling the operating pressures of later explained electro-pneumatic converters 8, 14 so that the flow rates output from the processing units 6, 12 become the set flow rates. Note that in the present embodiment, the control units 5, 11 are configured as separate members from the fluid mixing system so as to enable centralized control at a separate location, but they may also be provided integrally with the fluid mixing system.

8, 14 are electro-pneumatic converters provided in the control units 5, 11 for adjusting the operating pressures of the compressed air. The electro-pneumatic converters 8, 14 are comprised of electrically driven solenoid valves for proportionally adjusting the operating pressures and adjust the operating pressures of the fluid control valves 4, 10 in accordance with control signals from the control units 5, 11. Note that the electro-pneumatic converters 8, 14 need not be provided inside the control units 5, 11 and may also be provided as separate members.

Next, the operation of the fluid mixing system according to the first embodiment of the present invention will be explained.

Here, the first feed line 1 is charged with pure water, the second feed line 2 is charged with hydrofluoric acid, and the two fluids are mixed to give a ratio of pure water and hydrofluoric acid of 10:1. First, the pure water flowing in the first feed line 1 is measured for flow rate by the flow rate measuring device 3. In accordance with the measured flow rate, the control unit 5 controls the operating pressure of the fluid control valve 4. The fluid control valve 4 controls the flow rate at the downstream-most part of the first feed line 1 to become the set flow rate (flow rate whereby mixed fluid becomes set flow rate with ratio of flow rates of first feed line 1 and second feed line 2 of 10:1). Further, the hydrofluoric acid flowing in the second feed line 2 is measured for flow rate by the flow rate measuring device 9. In accordance with the measured flow rate, the control unit 11 controls the operating pressure of the second fluid control valve 10. The fluid control valve 10 controls the flow rate at the downstream-most part of the second feed line 2 to become the set flow rate (flow rate whereby mixed fluid becomes set flow rate with ratio of flow rates of first feed line 1 and second feed line 2 of 10:1). The pure water and hydrofluoric acid controlled in flow rates at the first and second feed lines 1, 2 merge at the header 15 and are mixed. The mixed fluid (dilute fluoric acid) is used in the treatment step of a washing apparatus of substrates. In the washing apparatus, the mixed fluid removes oxide films of the substrates.

Next, the operations of the flow rate measuring devices 3, 9, fluid control valves 4, 10, and control units 5, 11 will be explained with reference to FIG. 1 to FIG. 3.

The pure water and hydrofluoric acid flowing into the flow rate measuring devices 3, 9 are measured for flow rates at the straight channels 372. Ultrasonic vibrations are propagated through the flows of the pure water and hydrofluoric acid from the ultrasonic vibrators 374 positioned at the upstream sides to the ultrasonic vibrators 375 positioned at the downstream sides. The ultrasonic vibrations received by the ultrasonic vibrators 375 are converted into electrical signals and output to the processing units 6, 12 of the control units 5, 11. When ultrasonic vibrations are propagated from the upstream side ultrasonic vibrators 374 to the downstream side ultrasonic vibrators 375 for reception, transmission/reception is instantaneously switched in the processing units 6, 12, the ultrasonic vibrations are propagated from the ultrasonic vibrators 375 positioned at the downstream sides to the ultrasonic vibrators 374 positioned at the upstream sides. The ultrasonic vibrations received by the ultrasonic vibrators 374 are converted to electrical signals which are then output to the processing units 6, 12 in the control units 5, 11. At this time, the ultrasonic vibrations are propagated against the flows of fluids in the straight channels 372, so compared with the propagation of ultrasonic vibrations from the upstream sides to the downstream sides, the propagation speeds of the ultrasonic vibrations in the fluids are slower and the propagation times are longer. The output electrical signals are used in the processing units 6, 12 to calculate the propagation times. The flow rates are calculated from the differences in propagation times. The flow rates calculated at the processing units 6, 12 are converted to electrical signals and output to the controllers 7, 13.

Next, the pure water and hydrofluoric acid passing through the flow rate measuring devices 3, 9 flow into the fluid control valves 4, 10. The controllers 7, 13 of the control units 5, 11 output signals to the electro-pneumatic converters 8, 14 so as to reduce error to zero for error of the flow rates measured in real time from any set flow rates. The electro-pneumatic converters 8, 14 are driven to supply the corresponding operating pressures to the fluid control valves 4, 10. The flow rates of the pure water and hydrofluoric acid flowing out from the fluid control valves 4, 10 are determined by the relationship between the pressures adjusted by the fluid control valves 4, 10 and the pressure losses after the fluid control valves 4, 10. The higher the adjusted pressures, the larger the flow rates, while conversely the lower the pressures, the smaller the flow rates. For this reason, the pure water and hydrofluoric acid are controlled by the fluid control valves 4, 10 so that the flow rates become constant values of the set flow rates, that is, so that the errors between the set flow rates and the measured flow rates converge to zero.

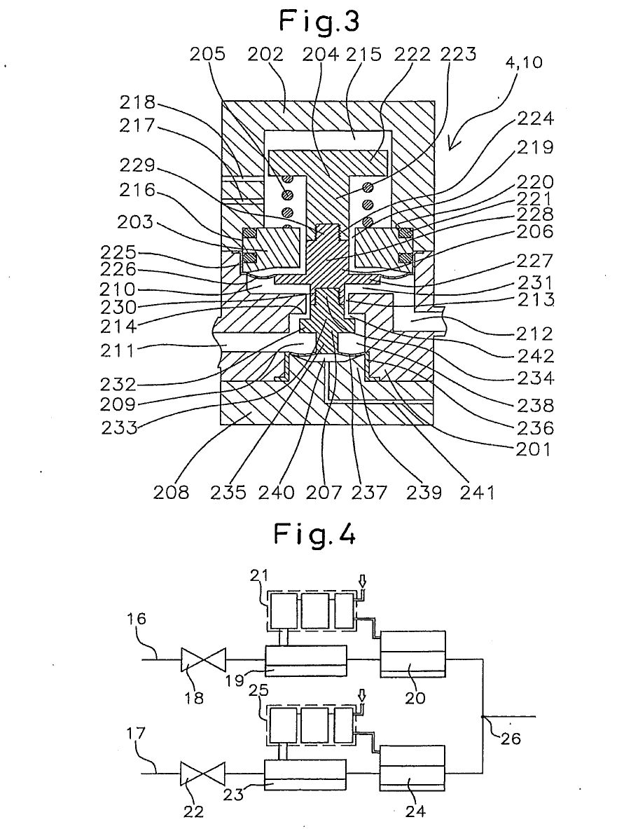

Here, the operation of the fluid control valves 4, 10 of the fluids (pure water or hydrofluoric acid) with respect to the operating pressures supplied from the electro-pneumatic converters 8, 15 will be explained (see FIG. 3).

The valve element 232 of the second valve mechanism 207 is acted on by the upward biasing force due to the springback force of the spring 205 sandwiched between the flange 222 of the piston 204 and the spring holder 203 and the fluid pressure at the bottom surface of the first diaphragm 227 of the first valve mechanism 206 and is acted on by the downward biasing force due to the pressure of the operating pressure of the top surface of the first diaphragm 227. More precisely, the bottom surface of the valve element 232 and the top surface of the second diaphragm 237 of the second valve mechanism 207 receive fluid pressure, but their pressure receiving areas are made substantially equal, so the forces are substantially cancelled out. Therefore, the valve element 232 of the second valve mechanism 207 stops at the position where the above three forces balance.

If increasing the operating pressure supplied from the electro-pneumatic converters 8, 14, the force pushing down the first diaphragm 227 increases, whereby the fluid control part 242 formed between the valve element 232 and valve seat 214 of the second valve mechanism 207 increases in opening area, so the first valve chamber 231 can be increased in pressure. Conversely, if decreasing the operating pressure, the fluid control part 242 decreases in opening area and the pressure also decreases. For this reason, by adjusting the operating pressure, it is possible to set any pressure.

In this state, when the upstream side fluid pressure increases, the pressure in the first valve chamber 231 also increases instantaneously. This being so, the force received by the bottom surface of the first diaphragm 227 from the fluid becomes larger than the force received by the top surface of the first diaphragm 227 from the compressed air due to the operating pressure, and the first diaphragm 227 moves upward. Along with this, the valve element 232 also moves upward in position, so the fluid control part 242 formed with the valve seat 214 decreases in opening area and the pressure in the first valve chamber 231 is decreased. Finally, the valve element 232 moves in position and stops at the position where the above three forces balance. At this time, if the load of the spring 205 does not greatly change, the pressure inside the cavity 215, that is, the force received by the top surface of the first diaphragm 227, is constant, so the pressure received by the bottom surface of the first diaphragm 227 becomes substantially constant. Therefore, the fluid pressure at the bottom surface of the first diaphragm 227, that is, the pressure inside the first valve chamber 231, becomes substantially the same as the original pressure as before the upstream side pressure increased.

When the upstream side fluid pressure decreases, the pressure in the first valve chamber 231 also instantaneously decreases. This being so, the force received by the bottom surface of the first diaphragm 227 from the fluid becomes smaller than the force received by the top surface of the first diaphragm 227 from the compressed air due to the operating pressure, and the first diaphragm 227 moves downward. Along with this, the valve element 232 also moves downward in position, so the fluid control part 242 formed with the valve seat 214 increases in opening area and the first valve chamber 231 increases in fluid pressure. Finally, the valve element 232 moves in position and stops at the position where the above three forces balance. Therefore, in the same way as when the upstream side pressure increases, the fluid pressure in the first valve chamber 231 becomes substantially the same as the original pressure.

Due to this, each of the fluid control valves 4, 10 is compact and enables stable control of the pressure of the fluid (pure water or hydrofluoric acid). The fluid pressure becomes constant, so the fluid flow rate also becomes constant. Further, even if the upstream side pressure of the fluid (pure water or hydrofluoric acid) fluctuates, the each of the fluid control valves 4, operates so that the flow rate is held automatically constant, so even if pump pulsation or other instantaneous fluctuations in pressure occur, the flow rate can be stably controlled.

Due to the above action, the pure water and hydrofluoric acid flowing into the first and second feed lines of the fluid mixing system are feedback controlled by the respective flow rate measuring devices 3, 9, fluid control valves 4, 10, and control units 5, 11 to stabilize the flow rates of the pure water and hydrofluoric acid in the feed lines with good response to the set flow rates, merge at the header 15, are mixed by the set ratio, and flow out. Further, by changing the flow rate settings of the control unit 5, 11, the flow rates of the fluids flowing through the first and second feed lines 1, 2 can be changed to the desired actual flow rates and the pure water and hydrofluoric acid can be automatically mixed at any ratio.

### Second Embodiment

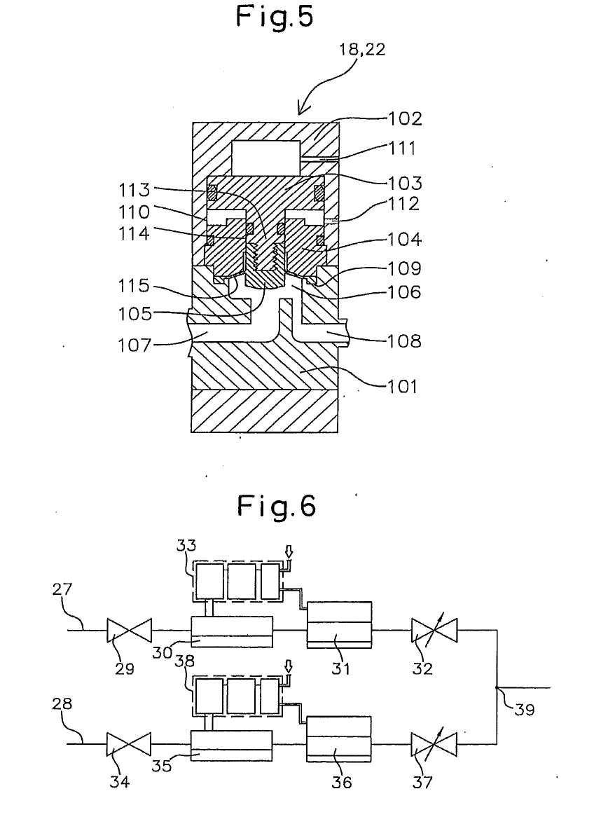

Next, a fluid mixing system of a second embodiment of the present invention will be explained based on FIG. 4 and FIG. 5.

This fluid mixing system is formed from two feed lines, that is, a first feed line 16 and a second feed line 17. The first feed line 16 has a shutoff valve 18, a flow rate measuring device 19, and a fluid control valve 20 connected to it in that order and is provided with a control unit 21, while the second feed line 17 has a shutoff valve 22, a flow rate measuring device 23, and a fluid control valve 24 connected to it in that order and is provided with a control unit 25. At the downstream-most sides of the first and second feed lines 16, 17, a header 26 of the feed lines 16, 17 is provided. The configurations of these components will be explained below.

18, 22 are shutoff valves. Each of the shutoff valves 18, 22 is formed by a body 101, drive unit 102, piston 103, diaphragm holder 104, and valve element 105.

101 is a PTFE body. This has a valve chamber 106 at the center of the top end in the axial direction and an inlet channel 107 and outlet channel 108 communicated with the valve chamber 106. The inlet channel 107 is communicated with an inlet port of the feed line 16 or 17, while the outlet channel 108 is communicated with the flow rate measuring device 19 or 23. Further, a ring-shaped groove 109 is provided at the outside of the valve chamber 106 on the top surface of the body 101.

102 is a PVDF drive unit. This is provided inside it with a cylindrical cylinder part 110 and is fastened to the top of the body 101 by bolts and nuts (not shown). The side surfaces of the drive unit 102 are provided with a pair of working fluid feed ports 111, 112 communicated with the top side and bottom side of the cylinder part 110.

103 is a PVDF piston. This is inserted inside the cylinder part 110 of the drive unit 102 in a sealing state to be able to move up and down in the axial direction. A rod 113 is provided suspended down from the center of its bottom surface.

104 is a PVDF diaphragm holder. This has a through hole 114 at its center through which the rod 113 of the piston 103 can pass and is clamped between the body 101 and the drive unit 102.

105 is a PTFE valve element held in the valve chamber 106. It is screwed together with the front end of the rod 113 of the piston 103 passed through the through hole 114 of the diaphragm holder 104 and projecting out from the bottom surface of the diaphragm holder 104 and moves up and down in the axial direction along with up and down motion of the piston 103. The valve element 105 has a diaphragm 115 at its outer circumference. The outer peripheral edge of the diaphragm 115 is inserted into a ring-shaped groove 109 of the body 101 and clamped between the diaphragm holder 104 and body 101. The rest of the configuration of the second embodiment is similar to that of the first embodiment, so explanations will be omitted.

Next, the operation of the fluid mixing system according to the second embodiment of the present invention will be explained.

Each of the shutoff valves 18, 22 operates so that when compressed air is charged from the working fluid feed port 112 from the outside as a working fluid, the pressure of the compressed air pushes the piston 103 up, so the rod 113 joined with this is lifted upward, the valve element 105 joined with the bottom end of the rod 113 is pulled upward, and the value is opened.

On the other hand, when compressed air is charged from the working fluid feed port 111, the piston 103 is pushed down. Along with this, the rod 113 and the valve element 105 joined to its bottom end are also pushed downward and the valve closes. The rest of the operation of the second embodiment is similar to that of the first embodiment, so explanations will be omitted.

Due to the above action, by providing shutoff valves at the feed lines, the fluids are cut off by the shutoff valves when closing the shutoff valves, so the flow rate measuring devices, fluid control valves, and control units of the different feed lines can be easily maintained. Further, when some sort of trouble occurs in the channels, the shutoff valves can be closed to shut off the flows of fluids on an emergency basis. For example, it is possible to prevent secondary disasters such as corrosion of parts in a semiconductor production system due to leakage of corrosive fluids. The rest of the operation of the second embodiment is similar to that of the first embodiment, so explanations will be omitted.

### Third Embodiment

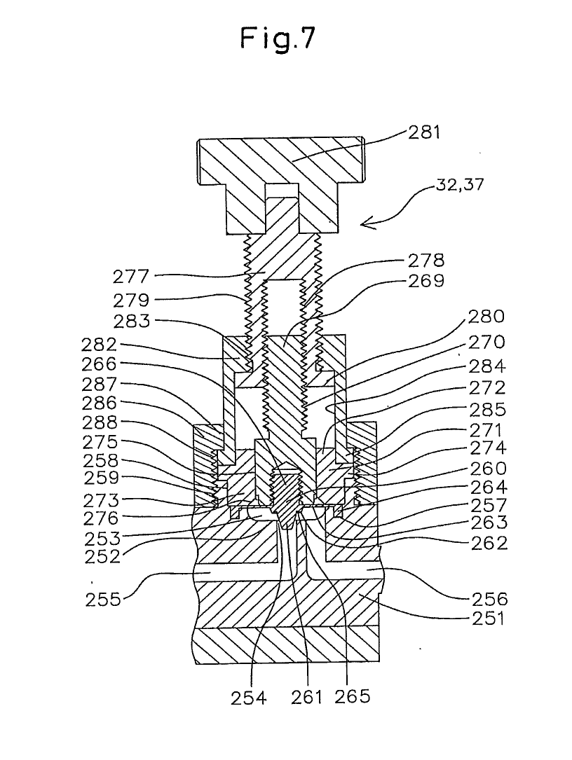

Next, a fluid mixing system of a third embodiment of the present invention will be explained based on FIG. 6 to FIG. 10.

This fluid mixing system is formed from two feed lines, that is, a first feed line 27 and a second feed line 28. The first feed line 27 has a shutoff valve 29, a flow rate measuring device 30, a fluid control valve 31, and a throttle valve 32 in that order and is provided with a control unit 33, while the second feed line 28 has a shutoff valve 34, a flow rate measuring device 35, a fluid control valve 36, and a throttle valve 37 connected to it in that order and is provided with a control unit 38. At the downstream-most sides of the first and second feed lines 27, 28, a header 39 of the feed lines 27, 28 is provided. The configurations of these components will be explained below.

32, 37 are throttle valves able to adjust the opening areas. Each throttle valve is formed by a body 251, diaphragm 260, second stem 269, diaphragm holder 271, first stem 277, first stem support 282, and bonnet 286.

251 is a PTFE body. It has a substantially dish shaped valve chamber 253 formed with the later explained diaphragm 260 at the top of the body 251. The bottom surface of the valve chamber 253 is formed with a valve seat surface 252 sealing closed the channel by the pressing action of the later explained second valve element 262 and has an inlet channel 255 communicating with the communication port 254 provided at the center of the valve seat surface 252 and the outlet channel 256 communicating with the valve chamber 253. Above the valve chamber 253, a recess 258 for receiving the engagement part 273 of the later explained diaphragm holder 271 is provided. At the bottom surface, a ring-shaped recess 257 with which the ring-shaped stop part 264 of the later explained diaphragm 260 fits is provided. Further, the outer circumference of the top of the body 251 is provided with a male thread 259 over which the later explained bonnet 286 is screwed.

260 is a PTFE diaphragm. This is integrally provided with a first valve element 261 projecting perpendicularly from the center of the liquid contact surface at the bottom of the diaphragm 260, a ring-shaped projection second valve element 262 with a front end of an arc-shaped cross-section formed at a position away from the first valve element 261 in the radial direction, a thin film part 263 formed continuing from the second valve element 262 in the radial direction, a ring-shaped stop part 264 with a rectangular cross-section at the outer circumference of the thin film part 263, and a connector 266 connected to the bottom end of the later explained second stem 269 at the top of the diaphragm 260. The first valve element 261 is provided by the successive straight part 267 and taper 268 downward. A ring-shaped groove 265 is formed between the first valve element 261 and the second valve element 262. In the ring-shaped groove 265, to suppress the flow of fluid in the space part, the volume of the space part formed between the ring-shaped groove 265 and valve seat surface 252 when fully closed is set to at least 2 times the volume of the space part formed between the straight part 267 of the first valve element 261 and the communication port 254 when fully closed. Further, as shown in FIG. 3, the straight part 267 of the first valve element 261 is set to an outside diameter D1 of 0.97D with respect to the inside diameter D of the communication port 254, the taper 268 of the first valve element 261 is set to a taper angle of 15° with respect to the axis taper, and the ring-shaped projection of the second valve element 262 is set to a diameter D2 of 1.5D with respect to the inside diameter D of the communication port 254. The diaphragm 260 is fastened clamped between the body 251 and the later explained diaphragm holder 271 in the state with the ring-shaped stop part 264 fit in the ring-shaped recess 257 of the body 251.

269 is a PP second stem. The outer circumference of the top of the second stem 269 is provided with a male thread 270 to be screwed with the female thread 278 of the later explained first stem 277, the outer circumference of the bottom part is formed in a hexagonal shape, and the bottom end is connected with the connector 266 of the diaphragm 260 by screwing.

271 is a PP diaphragm holder. The top of the diaphragm holder 271 is provided with an insert part 272 with a hexagonal outer circumference, while the bottom part is provided with an engagement part 273 with a hexagonal outer circumference, while the outer circumference of the center part is provided with a flange 274. The inner circumference of the diaphragm holder 271 is provided with a hexagonal shaped through hole 275. A taper 276 is provided reduced in size from the bottom end face toward the through hole 275. The insert part 272 is fit unpivotably in a hollow part 284 of the later explained first stem support 282, while the engagement part 273 is fit unpivotably in the recess 258 of the body 251. The through hole 275 has the second stem 269 inserted through it. The second stem 269 is supported to be able to move up and down and rotate.

277 is a PP first stem. The inner circumference of the bottom of the first stem 277 is provided with a female thread with a pitch of 1.25 mm into which the male thread 270 of the second stem 269 screws and a male thread 279 with a pitch of 1.5 mm at its outer circumference. The pitch difference between the male thread 279 and the female thread 278 is 0.25 mm and is formed to one-sixth the pitch of the male thread 279. The outer circumference of the bottom of the first stem 277 is provided with a stopper 280 provided projecting out in the radial direction, while the top has the handle 281 fastened to it.

282 is a PP first stem support. The inner circumference of the top of the first stem support 282 is provided with a female thread 283 screwed with the male thread 279 of the first stem 277, the inner circumference of the bottom is provided with a hexagonal shaped hollow part 284 in which the insert part 272 of the later explained diaphragm holder 271 unpivotably fits, and the outer circumference of the bottom is provided with a flange 285 fastened by the later explained bonnet 286.

286 is a PP bonnet. The top of the bonnet 286 is provided with a stop part 287 having an inside diameter smaller than the outside diameter of the flange 285 of the first stem support 282, while the inner circumference of the bottom is provided with a female thread 288 screwed with the male thread 259 of the body 251. The bonnet 286 screws the flange 285 of the first stem support 282 and the flange 274 of the diaphragm holder 271 into the body 251 in the state clamped between the stop part 287 and body 251 so as to fasten the parts. The pressure regulating valve 35 of the second feed line 28 is configured similar to the configuration of the first fluid control valve 4 of FIG. 3, so the explanation will be omitted. The rest of the configuration of the third embodiment is similar to the second embodiment, so the explanation will be omitted.

Next, the operation of the fluid mixing system of the third embodiment of the present invention will be explained.

Looking at the operation when the throttle valves 32, 37 finely adjust the opening degree, first, the fluid flowing in from the inlet channel 255 in the state where each of the throttle valves 32, 37 of the present embodiment is in the fully closed state (state of FIG. 9) is stopped by the second valve element 262 pressed against the valve seat surface 252.

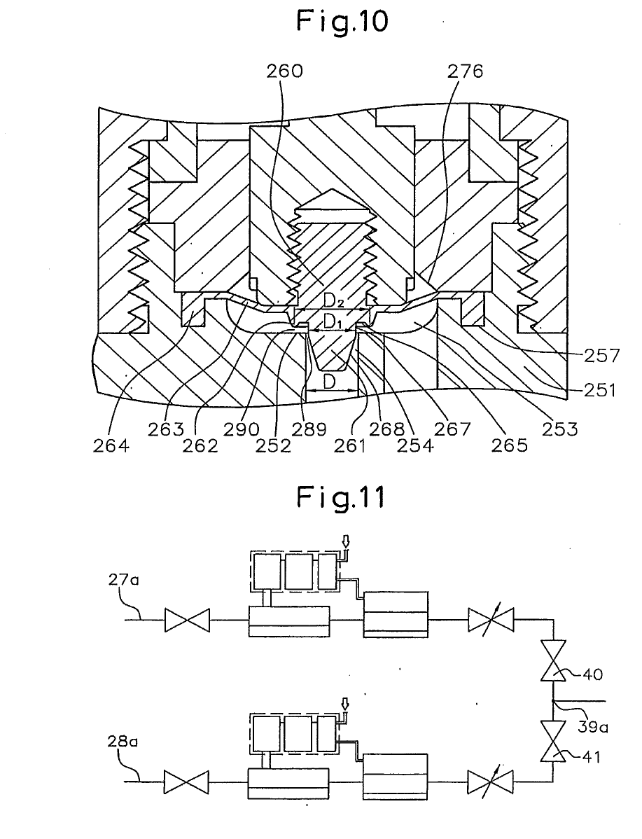

When the handle 281 is turned in the direction in which the valve opens, the rotation of the handle 281 is accompanied with the rise of the first stem 277 by exactly the pitch of the male thread 279 of the outer circumference and conversely with the descent of the second stem 269 screwed with the female thread 278 of the inner circumference of the first stem 277 by exactly the pitch of the female thread 278 of the first stem 277. However, the second stem 269 is housed in the through hole 275 of the diaphragm holder 271 in a rotatable state and can move in only the up-down direction, so the second stem 269 moves with respect to the body 251 by the pitch difference between the male thread 29 of the outer circumference of the first stem 277 and the female thread 278 of the inner circumference. In the present embodiment, the male thread 279 of the first stem 277 has a pitch of 1.5 mm, while the female thread 278 of the first stem 277 has a pitch of 1.25 mm, so by turning the handle 281 coupled with the first stem 277 one turn, the second stem 269 rises by 0.25 mm (one-sixth of pitch of male thread 279). Along with this, by the rise of the diaphragm 260 connected to the second stem 269, first the second valve element 262 pressed against the valve seat surface 252 of the body 251 separates from the valve seat surface 252, the first valve element 261 rises along with the rise of the diaphragm, and the throttle valve 32 or 37 becomes half opened (state of FIG. 10). The fluid flows in from the inlet channel 255 to the valve chamber 253 and passes through the outlet channel 256 to be exhausted.

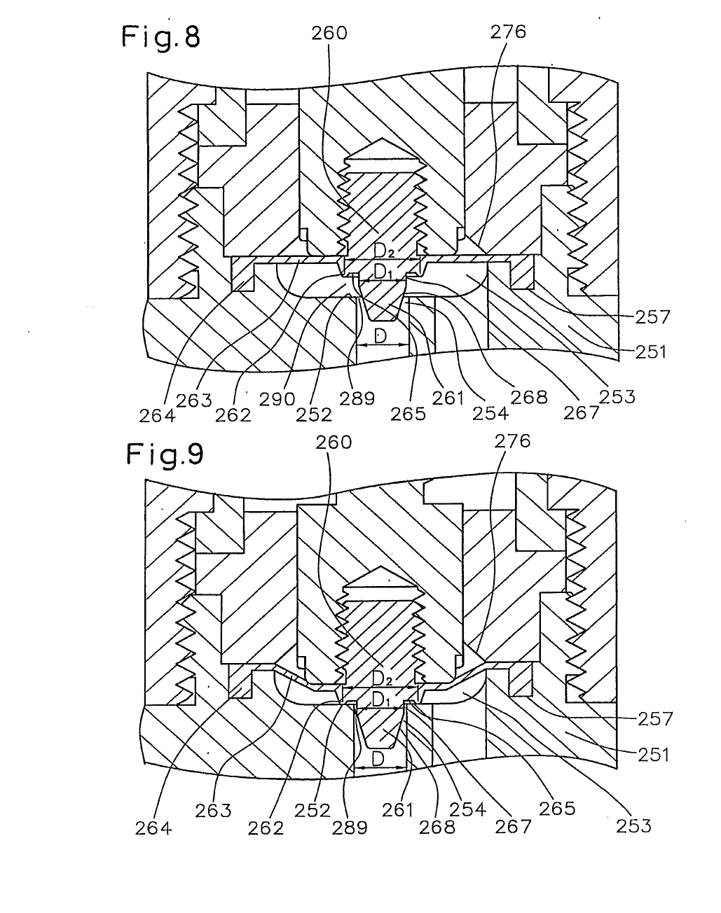

Next, when the handle 281 is further turned in the opening direction from the state where the throttle valve 32 or 37 is in the half open state (state of FIG. 10), the stopper part 280 of the outer circumference of the bottom of the first stem 277 abuts against the ceiling surface of the first stem support 282 and rotation stops. Along with the rotation of the handle 281, first stem 277, and second stem 269, the diaphragm 260 rises. The first valve element 261 and the second valve element 262 rise along with the rise of the diaphragm 260 and the valve reaches the fully open state (state of FIG. 8). Note that the first valve element 261 will not pull out of the communication port 254 even in the fully open state, so the throttle valve 32 or 37 adjusts the flow rate from the fully closed to fully opened state.

In the above action, from the fully closed to fully opened state of the throttle valve 32 or 37, the opening area S1 of the first flow rate adjuster 289 formed by the first valve element 261 and communication port 254 and the opening area S2 of the second flow rate adjuster 290 formed by the second valve element 262 and valve seat surface 252 change depending on the opening degree, but the action on adjusting the flow rate differs depending on the relative magnitude of S1 and S2. Below, the relationship of S1 and S2 from the fully closed to fully opened opening degree of the throttle valve 32 or 37 and the framework of adjustment of the flow rate will be explained based on FIG. 8 to FIG. 10.

When S1>S2, the opening degree of the throttle valve 32 or 37 is slightly open from fully closed. The flow rate is adjusted by the second flow rate adjuster 290, that is, by the magnitude of S2. In the range of S1>S2, the first flow rate adjuster 289 can adjust the flow rate to be constant at the straight part 267 of the first valve element 261 and the communication port 254. After the fluid is made constant in flow rate by the first flow rate adjuster 289, it first flows into the space part formed by the ring-shaped groove 265 before reaching the second flow rate adjuster 290. The fluid strikes the bottom surface of the ring-shaped groove 265, spreads in the radial direction and strikes the inner circumference of the second valve element 262, changes in direction of flow, and reaches the second flow rate adjuster 290, so the flow of fluid slows temporarily in the space part. Therefore, the fluid can be suppressed in flow in the space part and kept from rapidly increasing in flow rate. It reaches the second flow rate adjuster 290 by a flow sufficiently controllable at the second flow rate adjuster 290. The flow rate is precisely adjusted at the second flow rate adjuster 290, so the throttle valve 32 or 37 can be finely adjusted in flow rate when slightly open. At this time, the diameter D2 of the ring-shaped projection of the second valve element 262 is set within the range of 1.1D≦D2≦2D with respect to the inside diameter D of the communication port 254, so it is possible to form a ring-shaped groove 265 effective for suppressing the increase of flow rate between the first valve element 261 and the second valve element 262 and possible to suppress the flow of fluid from the first flow rate adjuster 289 in the space part formed by the ring-shaped groove 265.

When S1=S2, the opening area S1 of the first flow rate adjuster 289 and the opening area S2 of the second flow rate adjuster 290 become the same. The part for adjusting the flow rate is switched at this point of time from the second flow rate adjuster 290 to the first flow rate adjuster 289. That is, the flow rate is adjusted by the magnitude of S1.

When S1<S2, the opening degree of the throttle valve 32 or 37 is increased from slightly open until fully open. With the second flow rate adjuster 290, fine adjustment of the flow rate becomes difficult. Therefore, the first flow rate adjuster 289 is used for adjustment by the magnitude of S1. In the range of S1<S2, the first flow rate adjuster 289 adjusts the flow rate by the taper 268 of the first valve element 261 and the communication port 254. The taper 268 of the first valve element 261 is set so that the opening degree S1 increases proportionally to the opening degree of the throttle valve 32, so the flow rate can be adjusted to increase linearly as the opening degree of the throttle valve 32 is increased.

From this, each of the throttle valves 32, 37 of the present invention adjusts the flow rate by the second flow rate adjuster 290 when the opening degree is fine. When increasing the opening degree, it switches from the second flow rate adjuster 290 to the first flow rate adjuster 289 to adjust the flow rate, so it is possible to obtain a proportional relationship giving a good flow rate with respect to the opening degree from fully closed to fully open, possible to reliably adjust the flow rate from a fine flow rate to a large flow rate, and possible to adjust the flow rate in a broad range of flow rate.

Next, when turning the handle 281 in the opposite direction from the fully open state, the throttle valve 32 or 37 operates in the reverse from the case when turning it in the opening direction. The valve element descends and the flow rate is adjusted in accordance with the opening degree of the throttle valve 32 or 37. When turning the handle 281 in the closing direction to set the fully closed state, the second valve element 262 and the valve seat surface 252 come in line contact and enable a reliable fully closed seal. When the throttle valve 32 or 37 is fully closed, the first valve element 261 does not contact the communication port 254 at any time, so it is possible to prevent loss of stability of the adjustment of the flow rate due to long term use without deformation of the valve element or valve seat surface 252 due to abrasion etc. due to long-term use of the throttle valve 32 or 37.

Due to the above action, the feedback controlled fluids are stably controlled to become the set flow rates by fine adjustment of the flow rates by the throttle valves 32, 37. Further, by changing the opening degrees of the throttle valve 32, 37, it is possible to control the flow rate of each feed line over a broad range of flow rate. Further, the throttle valves are configured to facilitate fine adjustment of the opening degrees, so the opening degrees can be finely adjusted precisely in a short time. The rest of the operation of the third embodiment is similar to the second embodiment, so the explanation will be omitted.

### Fourth Embodiment

Next, a fluid mixing system of a fourth embodiment of the present invention will be explained based on FIG. 11.

The fluid mixing system of the present embodiment is configured like in the third embodiment but providing a shutoff valve 40 right before the header 39a of the first feed lines 27a and providing a shutoff valve 41 right before the header 39a of the second feed line 28a. The shutoff valves 40, 41 are configured as shown in FIG. 5. The feed lines are configured in the same way as in the third embodiment, so explanations are omitted.

Next, the operation of the fluid mixing system according to the fourth embodiment of the present invention will be explained.

Here, the first feed line 27a is charged with pure water, the second feed line 28a is charged with hydrofluoric acid, and the fluids are mixed to give a ratio of pure water and hydrofluoric acid of 10:1. When the shutoff valves 40, 41 are in the open state, the pure water and hydrofluoric acid controlled in flow rates at the first and second feed lines 27a, 28a merge at the header 39a, are mixed by the set ratio (ratio of flow rates of first feed line 27a and second feed line 28a of 10:1), and flow out by the set flow rate. The obtained mixed fluid is introduced from the fluid mixing system into the washing tank of a substrate washing apparatus and used to remove the oxide films from substrates. When the shutoff valve 40 is open and the shutoff valve 41 is closed, only pure water controlled at the first feed line 27a flows out. When the shutoff valve 40 is closed and the shutoff valve 41 is open, only hydrofluoric acid controlled at the second feed line 28a flows out. The operations of the feed lines are similar to those of the third embodiment, so explanations will be omitted.

According to the above action, by providing the shutoff valves 40, 41 right before the header 39a, it is possible to selectively feed the pure water of the first feed line 27a, the hydrofluoric acid of the second feed line 28a, and a mixed fluid of these fluids and possible to make them flow out at any flow rates.

### Fifth Embodiment

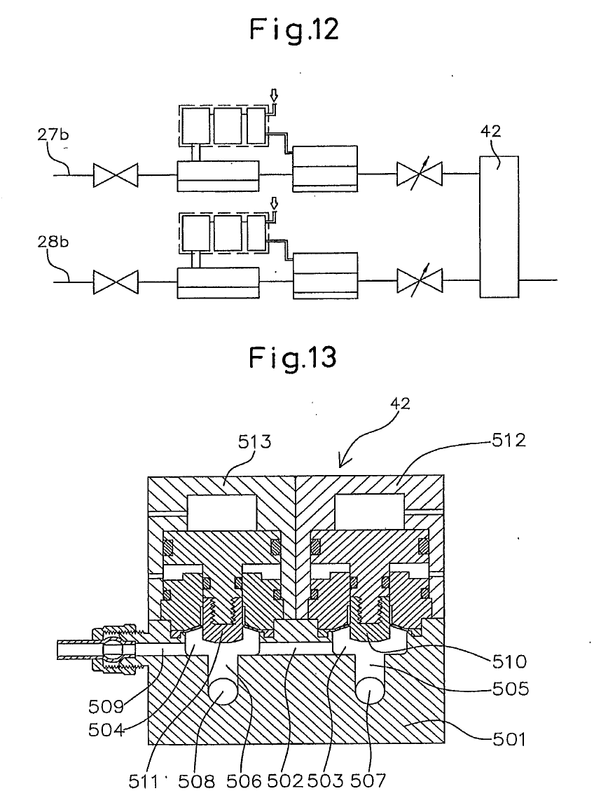

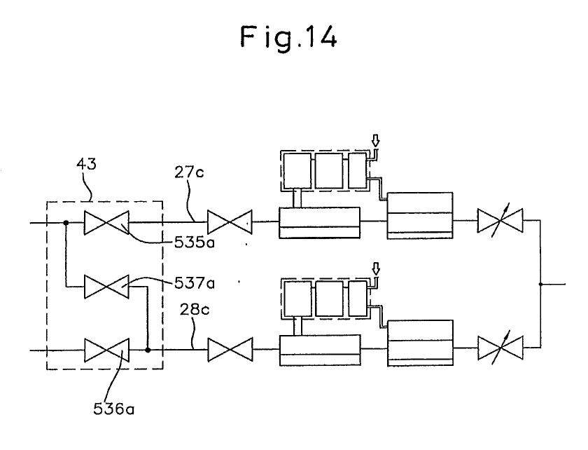

Next, a fluid mixing system of a fifth embodiment of the present invention will be explained based on FIG. 12 and FIG. 13.

The fluid mixing system of the present embodiment is configured like in the third embodiment but provides a manifold valve 42 at the header of the first and second feed lines 27b, 28b. The configuration of the components are as follows:

42 is a manifold valve. The manifold valve 42 is formed from a body 501, first valve element 510, second valve element 511, and drive units 512, 513.

501 is a body. At the top of the body 501, a cylindrical first valve chamber 503 and second valve chamber 504 communicated by a communication channel 502 are provided. The first valve chamber 503 is provided with a first communication port 505 at the center of its bottom. The first communication port 505 is provided with a first channel 507 communicating with the first feed line 27b. The second valve chamber 504 is provided with a second communication port 506 at the center of its bottom. The second communication port 506 is provided with a second channel 508 communicating with the second feed line 28b. Further, the first valve chamber 503 is provided with a branch channel 509 from which fluid mixed in the manifold valve flows. The first channel 507 and the second channel 508 are provided in parallel at the same side surface of the body 501, while the branch channel 509 is provided in a direction perpendicular to the channels 507, 508.

510 is a first valve element opening and closing the first communication port 505 and is housed in the first valve chamber 503. 511 is a second valve element opening and closing the second communication port 506 and is housed in the second valve chamber 504. 512 is a drive unit for operating the first valve element 510 to open and close the valve, while 513 is a drive unit for operating the second valve element 511 to open and close the valve. The drive units 512, 513 are configured the same as the drive unit 102 of the shutoff valve of FIG. 5, so their explanations are omitted. The feed lines are configured in the same way as in the third embodiment, so their explanations will be omitted.

Next, the operation of the fluid mixing system according to the fifth embodiment of the present invention will be explained.

Here, the first feed line 27b is charged with pure water, the second feed line 28b is charged with hydrofluoric acid, and the fluids are mixed to give a ratio of pure water and hydrofluoric acid of 10:1. When the drive unit 512 of the manifold valve 42 raises the first valve element 510 to open the first communication port 505 and the drive unit 513 raises the second valve element 511 to open the second communication port 506 (state of FIG. 13), the pure water controlled at the first feed line 27b passes through the first channel 507 to flow into the first valve chamber 503, the hydrofluoric acid controlled at the second feed line 28b passes through the second channel 508 to flow into the second valve chamber 504, the pure water and hydrofluoric acid merge at the second valve chamber 504, the fluids are mixed by the set ratio (ratio of flow rates of first feed line 27b and second feed line 28b of 10:1), and mixed fluid flows out from the branch channel 509 by the set flow rate. The obtained mixed fluid is introduced from the fluid mixing system into a washing tank of a substrate washing apparatus and is used for removing the oxide films from the substrates.

When similarly driving the drive units 512, 513 to open the first communication port 505 and close the second communication port 506, the second feed line 28b is closed and does not carry fluid, while the pure water controlled at the first feed line 27b passes through the first channel 507, first valve chamber 503, and second valve chamber 504 and flows out from the branch channel 509.

When similarly driving the drive units 512, 513 to close the first communication port 505 and open the second communication port 506, the first feed line 27b is closed and does not carry fluid, while the hydrofluoric acid controlled at the second feed line 28b passes through the second channel 508 and the second valve chamber 504 and flows out from the branch channel 509. The operations of the feed lines are similar to those in the third embodiment, so explanations will be omitted.

Due to the above action, by providing the manifold valve 42, it is possible to selectively feed the pure water of the first feed line 27b, the hydrofluoric acid of the second feed line 28b, and the mixed fluid of the two fluids and possible to discharge them at any flow rates. Further, due to the above configuration, the fluid mixing system can be made compact and the channels can be switched at the header.

### Sixth Embodiment

Next, a fluid mixing system of a sixth embodiment of the present invention will be explained based on FIG. 14 to FIG. 16.

The fluid mixing system of the present embodiment is configured like in the third embodiment but provides a flushing system 43 at the upstream-most sides of the first and second feed lines. The flushing system 43 is configured as follows:

43 is a flushing system provided at the upstream-most sides of the two feed lines. The flushing system 43 is formed by a body 531 formed with channels and a drive unit A532, drive unit B533, and drive unit C534 for opening and closing the channels. The configuration of the components are as follows:

531 is a PTFE body. The body 531 is provided at its top with a dish-shaped valve chamber A535 and valve chamber B536 while the body 531 is provided at its bottom with a valve chamber C537. The valve chamber B536 and the valve chamber C537 are provided arranged at the top and bottom of the body 531 on substantially the same axis. At the bottom surface of the valve chamber A535, a valve seat is formed for closing and sealing the channel by being pressed against by a later explained valve element A550. An inlet channel A538 communicating with a communication port provided at the center of the valve seat and an outlet channel A539 communicating with the valve chamber A535 are provided. The valve chamber B536 and valve chamber C537 are also formed with valve seats at their bottom surfaces in the same way as the valve chamber A535. An inlet channel B540 and outlet channel B541 communicating with the valve chamber B536 and an inlet channel C542 and outlet channel C543 communicating with the valve chamber C537 are provided.

Further, the body 531 is provided at one side surface with a first inlet 544 and second inlet 545 and is provided at the other side surface with a first outlet 546 and second outlet 547. The channel communicating with the first inlet 544 is divided into two channels at a first branch 548 whereby channels communicating with the inlet channel A538 and inlet channel C542 are formed. The channel communicating with the first outlet 546 communicates with the outlet channel A539. The channel communicating with the second inlet 545 communicates with the inlet channel B540. The channel communicating with the second outlet 547 is divided into two channels at a second branch 549, whereby channels communicating with the outlet channel B541 and outlet channel C543 are formed. Further, the first outlet 546 communicates with the first feed line 27c, while the second outlet 547 communicates with the second feed line 28c.

At this time, the channel formed communicating from the first inlet 544 through the inlet channel A538, valve chamber A535, and outlet channel A539 to the first outlet 546 will be referred to as the “main line”, that is, the “first line”, the channel formed communicating from the second inlet 545 through the inlet channel B540, valve chamber B536, and outlet channel B541 to the second outlet 547 will be referred to as the “second line”, and the channel formed communicating from the first branch 548 through the inlet channel C542, valve chamber C537, and outlet channel C543 to the second branch 549 will be referred to as the “communication line”.

532, 533, 534 are PVDF drive units A, B, C. The drive unit A532, drive unit B533, and drive unit C534 are provided with a valve element A550, valve element B551, and valve element C552 opening and closing the valves by pressing against and separating from the valve seats of the valve chamber A535, valve chamber B536, and valve chamber C537. The drive units 532, 533, 534 are configured in the same way as the drive unit 102 of the shutoff valve of FIG. 5, so the explanations will be omitted.

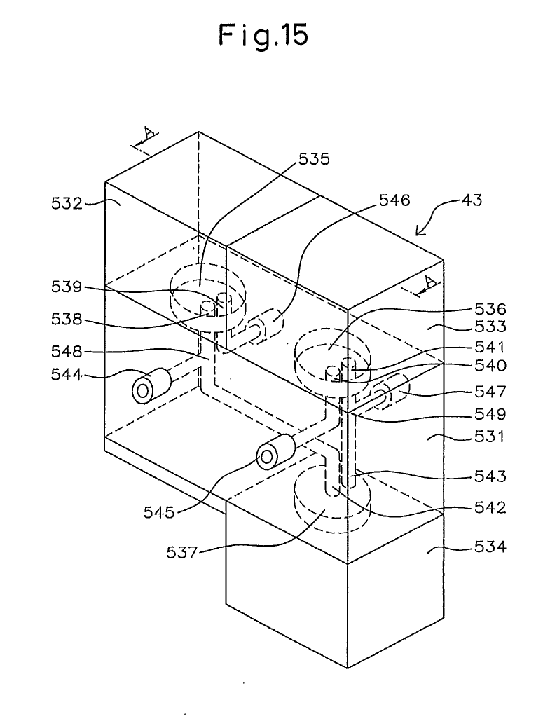

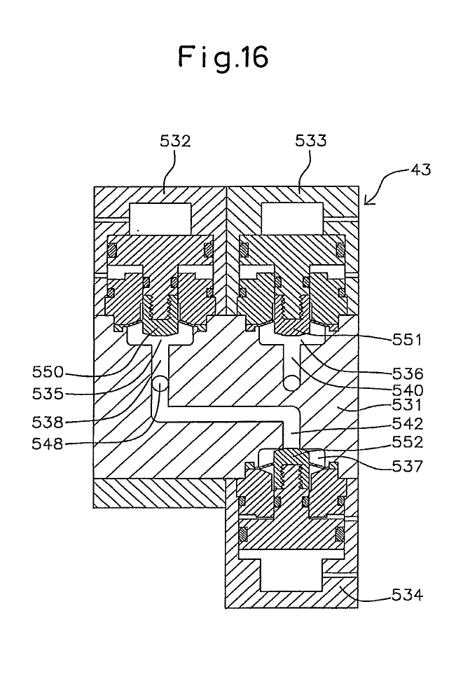

Here, the shutoff valve 535a in FIG. 14 corresponds to the part formed by the valve chamber A535 and valve element A550 of the drive unit A532 in FIG. 15, FIG. 16, the shutoff valve 536a corresponds to the part formed by the valve chamber B536 and the valve element B551 of the drive unit B533, and the shutoff valve 537a corresponds to the part formed by the valve chamber C537 and the valve element C552 of the drive unit C534. The feed lines are configured in the same way as in the third embodiment, so explanations are omitted.

Next, the operation of the fluid mixing system according to the sixth embodiment of the present invention will be explained.

Here, the first feed line 27c is charged with pure water, the second feed line 28c is charged with hydrochloric acid, and the fluids are mixed to give a ratio of pure water and hydrochloric acid of 20:1. In the normal mode, the valve element A550 and the valve element B551 are pulled upward to open the valve chamber A535 and valve chamber B536 and the valve element C552 is pushed downward (upward in the figure) to close the valve chamber C537 (state of FIG. 16). At this time, pure water and hydrochloric acid flow independently in the first line and second line. Here, if the first inlet 544 is charged with pure water and the second inlet 545 is charged with hydrochloric acid, the pure water flowing to the first inlet 544 passes through the inlet channel A538, valve chamber A535, and outlet channel A539 and flows from the first outlet 546 to the first feed line 27c, while the hydrochloric acid flowing into the second inlet 545 passes through the inlet channel B540, valve chamber B536, and outlet channel B541 and flows from the second outlet 547 to the second feed line 28c. The actions of these feed lines are similar to those of the third embodiment, so the explanations will be omitted here. At this time, the first feed line 27c and the second feed line 28c are set for mixture by a 20:1 flow rate ratio and for discharge by the set flow rate. The discharged mixed fluid is introduced from the fluid mixing system to the washing tank of a substrate washing apparatus and used to remove oxide films from the substrates.

In the flushing mode, the valve element A550 and the valve element B551 are pushed downward to close the valve chamber A535 and the valve chamber B536 and the valve element C552 is pulled upward to open the valve chamber C537. At this time, the first line and the second line are connected by the communication line and a channel is formed from the first inlet 544 to the second outlet 547. Here, the pure water flowing in the first feed line 27c flows from the first inlet 544 through the first branch 548, inlet channel C542, valve chamber C537, outlet channel C543, and second branch 549 and flows from the second outlet 547 to the second feed line 28c. By continuing to run pure water, it is possible to flush the second feed line 28c with pure water and wash the inside of the second feed line 28c.

Due to the above action, by providing the flushing system 43 of the present embodiment, it is possible to easily select the normal mode and flushing mode and flush the feed lines by the flushing mode so as to wash them. Further, the flushing system 43 of the present embodiment has the channels formed in the body 531, that is, a single base block, so it is possible to provide the flushing system 43 as a single member. There is no need to provide channels of the flushing system 43 by pipes etc., so the number of parts can be reduced, the flushing system 43 can be formed more compact, and the channels can be shortened, so the fluid resistance can be suppressed.

### Seventh Embodiment

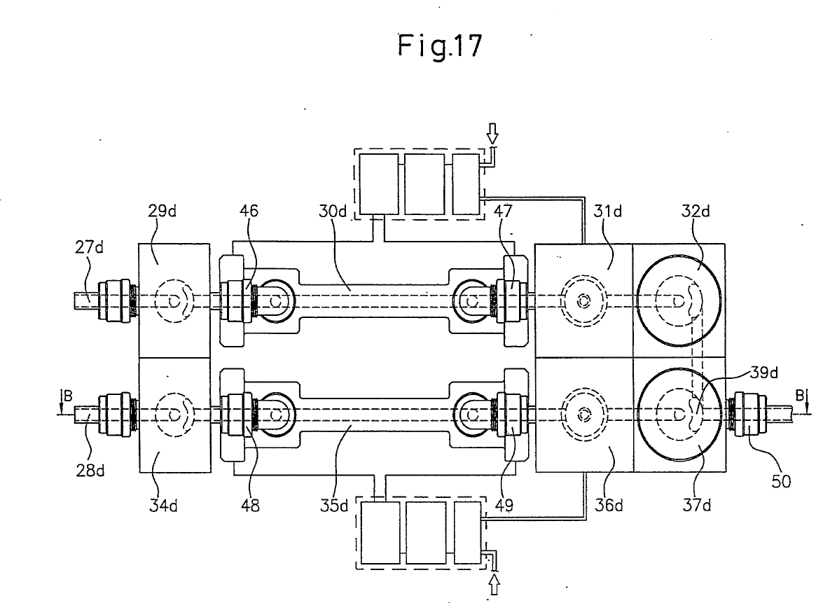

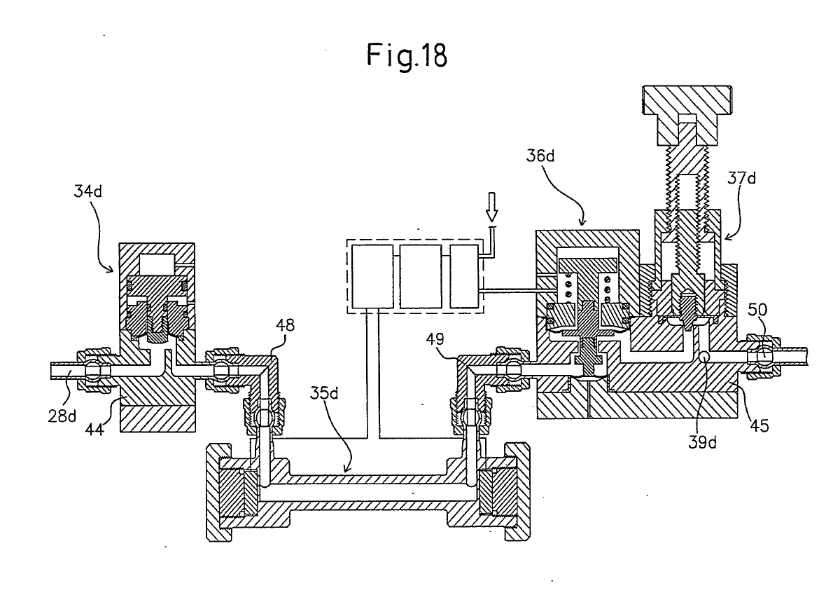

Next, a fluid mixing system of a seventh embodiment of the present invention will be explained based on FIG. 17 and FIG. 18.

The fluid mixing system of the present embodiment is comprised of the third embodiment except the shutoff valves 29d, 34d of the first and second feed lines 27d, 28d are provided on a single base block 44, the fluid control valves 31d, 36d and throttle valves 32d, 37d of the first and second feed lines 27d, 28d are provided on a single base block 45, and the flow rate measuring devices 30d, 35d are connected to the base blocks 44, 45 through the connection members 46, 47, 48, 49. This is the method of direct connection in the case of not using any separate tubes or pipes. The parts are configured as follows.

44 is a base block on which the shutoff valves 29d, 34d of the first and second feed lines 27d, 28d are provided. The base block 45 is formed with a channel of the shutoff valve 29d of the first feed line 27d and a channel of the shutoff valve 34d of the second feed line 28d communicated in that order.

45 is a base block on which of the fluid control valves 31d, 36d and throttle valves 32d, 37d of the first and second feed lines 27d, 28d are provided. The base block 45 is formed with a channel of the fluid control valve 31d and throttle valve 32d of the first feed line 27d and a channel of the fluid control valve 36d and throttle valve 37d of the second feed line 28d. Further, the outlet channel of the throttle valve 32d of the first feed line 27d communicates with the outlet channel of the throttle valve 37d of the second feed line 28d to form the header 39d and is communicated from the header 39d to the outlet port 50. Note that the header 39d need not be provided in the base block 45. It is also possible to merge the channels from the feed lines of the base block 45.

46, 47, 48, 49 are connection members for changing the directions of the channels. The outlet channels of the shutoff values 29d, 34d are directly connected to the inlet channels of the flow rate measuring devices 30d, 35d while changed in direction through the connection members 46, 48, while the outlet channels of the flow rate measuring devices 30d, 35d are directly connected to the inlet channels of the fluid control valves 31d, 36d while changed in direction through the connection members 47, 49. The configurations and operations of the valves and flow rate measuring devices of the feed lines are similar to those of the third embodiment, so explanations will be omitted.

Since, due to this, the adjoining valves and flow rate measuring devices are directly connected without using independent connecting means of tubes or pipes, the fluid mixing system can be made compact and the space taken at the installation site can be reduced. Further, the installation work becomes easier, the work time can be shortened, and the channels in the fluid mixing system can be shortened, so the fluid resistance can be suppressed.

### Eighth Embodiment

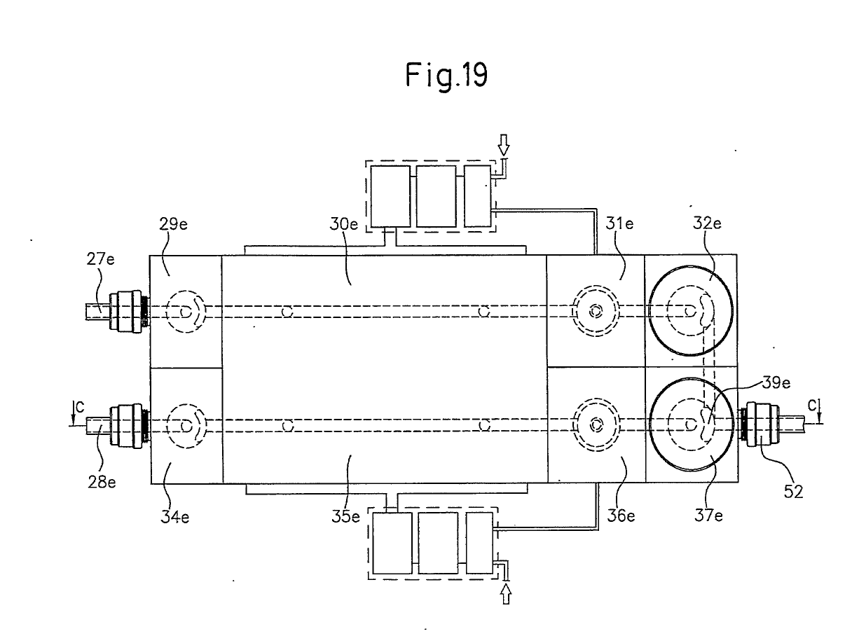

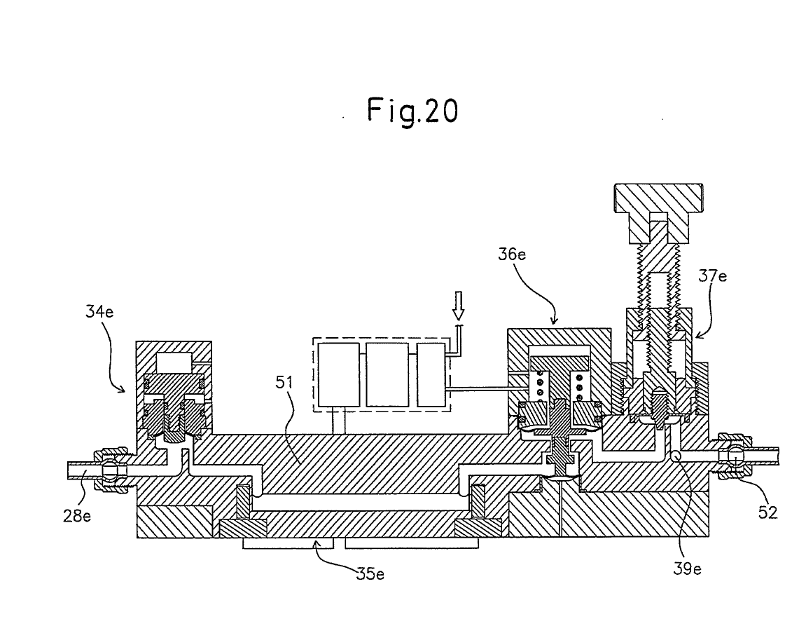

Next, a fluid mixing system of an eighth embodiment of the present invention will be explained based on FIG. 19 and FIG. 20.

The fluid mixing system of the present embodiment is configured like in the third embodiment but provides the shutoff valves 29e, 34e, flow rate measuring devices 30e, 35e, fluid control valves 31e, 36e, and throttle valves 32e, 37e of the first and second feed lines 27e, 28e in that order. The configuration of the components are as follows:

51 is a base block at which the shutoff valves 29e, 34e, flow rate measuring devices 30e, 35e, fluid control valves 31e, 36e, and throttle valves 32e, 37e of the first and second feed lines 27e, 28e are provided. The base block 51 is formed with a channel of the shutoff valve 29e, flow rate measuring device 30e, fluid control valve 31e, and throttle valve 32e of the first feed line 27e and a channel of the shutoff valve 34e, flow rate measuring device 35e, fluid control valve 36e, and throttle valve 37e of the second feed line 28e communicated in that order. Further, the outlet channel of the throttle valve 32e of the first feed line 27e communicates with the outlet channel of the throttle valve 37e of the second feed line 28e to form a header 39e and communicates with the outlet 52 from the header 39e. Note that the header 39e need not be provided in the base block 51. It is also possible to merge the channels from the feed lines of the base block 51. The configurations and operations of the valves and flow rate measuring devices of the feed lines are similar to those of the third embodiment, so explanations will be omitted.

Due to this, since the fluid mixing system is provided at a single base block 51 formed with the channels, the fluid mixing system can be made compact and the space used at the installation site can be reduced. Further, the installation work becomes easier, the work time can be shortened, and the channels in the fluid mixing system can be shortened, so the fluid resistance can be reduced. Further, the number of parts can be reduced, so the fluid mixing system can be easily assembled.

### Ninth Embodiment

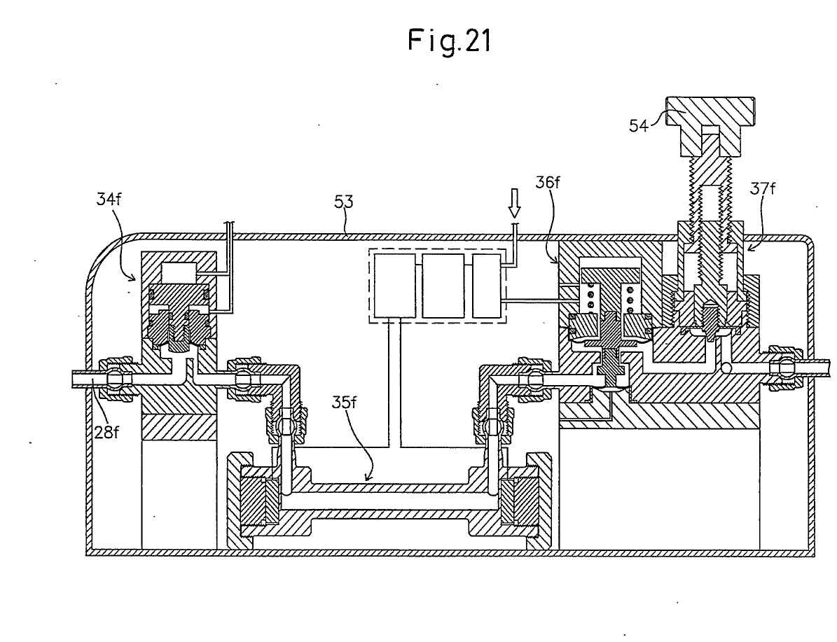

Next, a fluid mixing system of a ninth embodiment of the present invention will be explained based on FIG. 21. Note that in the present embodiment, the explanation will be given by only a vertical cross-sectional view of the second feed line side of FIG. 21.

The fluid mixing system of the present embodiment is configured like in the third embodiment but provides the shutoff valves 34f, flow rate measuring devices 35f, fluid control valves 36f, and throttle valves 37f of the first and second feed lines 28f housed in a single casing 53. These are configured as follows:

53 is a PVDF casing. Inside the casing 53, at the bottom surface of the casing 53, the shutoff valves 34f, flow rate measuring devices 35f, fluid control valves 36f, and throttle valves 37f are fastened in that order by bolts and nuts (not shown). Further, control units are provided above the flow rate measuring devices 35f fastened to the top of the casing 53. The handles 54 of the throttle valves 27f are provided projecting from the casing 53. The connection structures of the valves and flow rate measuring devices of the present embodiment are similar to those of the seventh embodiment. The configurations and operations of the valves and flow rate measuring devices of the feed lines are similar to those of the third embodiment, so the explanations will be omitted.

Due to this, since the fluid mixing system is provided in a single casing 53 and the fluid mixing system becomes a single module, installation becomes easy, the work time in the installation work can be shortened, the parts are protected by the casing, and the fluid mixing system is made a “black box” so easy disassembly of the fluid mixing system can be prevented and trouble caused by unknowledgeable users disassembling the fluid mixing system can be prevented.

### 10th Embodiment

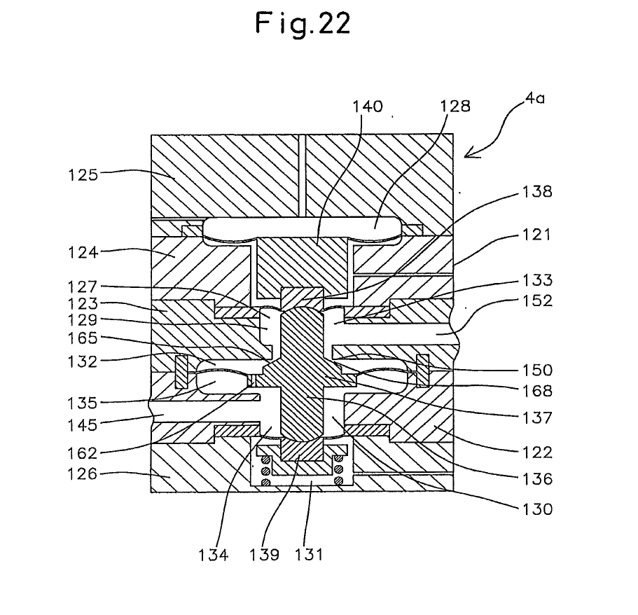

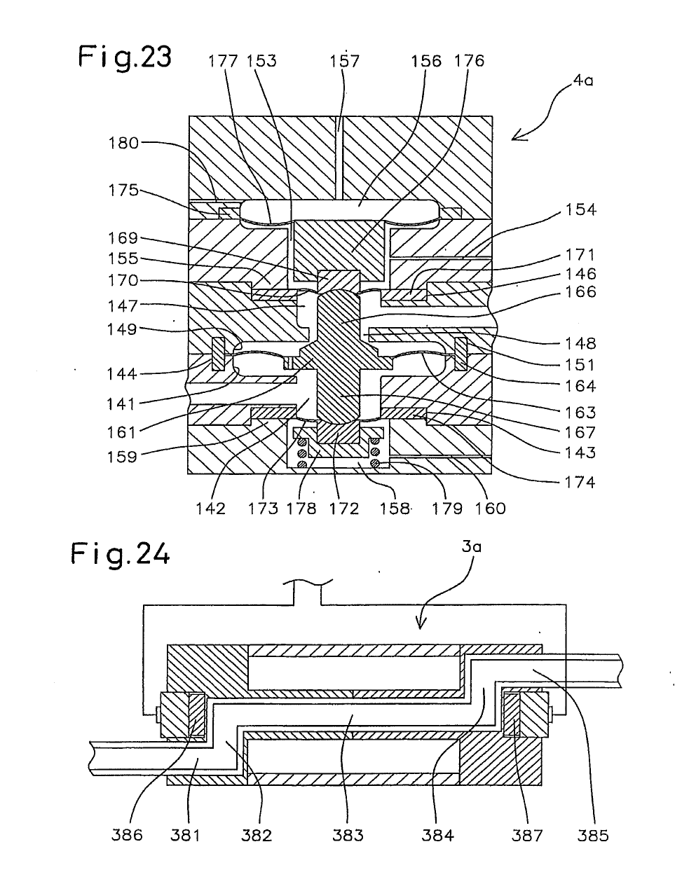

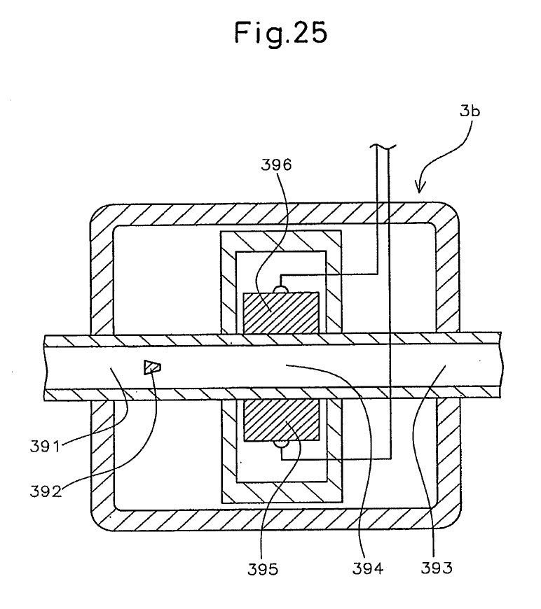

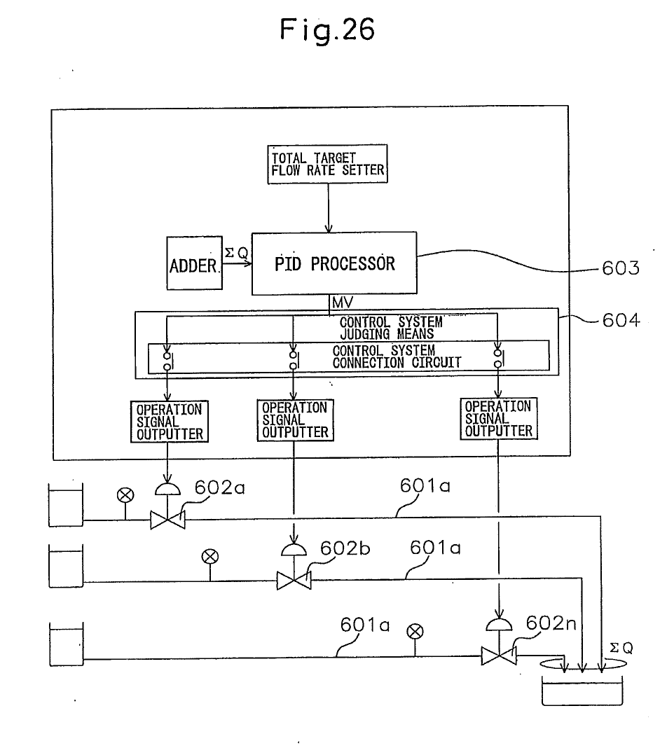

Next, a fluid mixing system of a 10th embodiment of the present invention will be explained based on FIG. 22 and FIG. 23. Here, the case where the fluid control valves 4, 10 of the first embodiment are replaced with the fluid control valves 4a of the present embodiment comprised of other fluid control valves will be explained.

4a is a first fluid control valve. The fluid control valve 4a is formed by a body 121, valve member 136, first diaphragm 137, second diaphragm 138, third diaphragm 139, and fourth diaphragm 140.

The body 121 has inside it a chamber 127 divided into a later explained first pressurized chamber 128, second valve chamber 129, first valve chamber 130, and second pressurized chamber 131, an inlet channel 145 for inflow of fluid from the outside to the chamber 127, and an outlet channel 152 for outflow from the chamber 127. From the above, it is divided into the body D125, body C124, body B123, body A122, and body E126. It is comprised by assembly of these together.

122 is a PTFE body A positioned at the inside of the body 121. Its top is provided with a flat circular shaped step 141. At the center of the step 141, an opening 142 forming the bottom first valve chamber 134 smaller in diameter than the step 141 and, below the opening 142, a flat circular shaped bottom step 143 larger in diameter than the opening 142 are provided continuously. At the top surface of the body A122, that is, the peripheral edge of the step 141, a ring-shaped recessed groove 144 is provided. Further, an inlet channel 145 communicating from the side surface to the opening 142 of the body A122 is provided.

123 is a PTFE body B fastened by engagement with the top surface of the body A122. Its top is provided with a flat circular shaped step 146. At the center of the step 146, an opening 147 forming the top second valve chamber 133 smaller in diameter than the step 146 is provided. Below the opening 147, an opening 148 smaller in diameter than the diameter of the opening 147 and a flat circular shaped bottom step 149 the same in diameter as the step 141 of the body A122 are continuously provided. The circumference of the bottom end of the opening 148 forms the valve seat 150. The bottom surface of the body B123, that is, the peripheral edge of the bottom step 149, is provided with a ring-shaped recessed groove 151 at a position of the body A122 facing the ring-shaped recessed groove 144. Further, an outlet channel 152 is provided communicating from the side surface of the body B123 to the opening 147 positioned at the opposite side to the inlet channel 145 of the body A122.

124 is a PTFE body C fastened by engagement with the top of the body B123. It is provided at its center with a flat circular shaped diaphragm chamber 153 passing through the top and bottom end faces of the body C124 and enlarged in diameter at the top, a breathing hole 154 communicating the diaphragm chamber 153 and the outside, and a ring-shaped projection 155 engaged with the step 146 of the body B123 at its bottom end face and centered about the diaphragm chamber 153.

125 is a PTFE body D positioned at the top of the body C124. It is provided at its bottom with an air chamber 156 and, at its center, with an air feed hole 157 provided passing through the top surface and introducing compressed air from the outside to the air chamber 156. Further, a fine exhaust hole 180 is provided passing through the side surface. Note that the exhaust hole 180 need not be provided when not necessary for feeding compressed air.

126 is a PVDF body E fastened by engagement with the bottom of the body A122. It is provided at the center part with an opening 158 opening to the top surface and forming a second pressurized chamber 131 and is provided at the circumference of the top surface of the opening 158 with a ring-shaped projection 159 fastened by engagement with the bottom step 143 of the body A122. Further, the side surface of the body E126 is provided with a small diameter breathing hole 160 communicated from there to the opening 158.

The five body A122, body B123, body C124, body D125, and body E126 forming the body 121 explained above are fastened by clamping by bolts and nuts (not shown).

136 is a PTFE valve member. It has first diaphragm 137 having a thick part 161 provided in a flange shape at its center, a communication hole 162 provided passing through the thick part 161, a circular shaped thin film part 163 provided extending out from the outer circumference of the thick part 161 in the radial direction, and a ring-shaped rib 164 provided projecting out to the top and bottom at the outer peripheral edge of the thin film part 163, a dish shaped valve element 165 provided at the center of the top of the first diaphragm 137, a top rod 166 provided projecting upward from the top of the valve element 165 and with a top end formed into a substantially semispherical shape, and a bottom rod 167 provided projecting downward from the center of the bottom end face of the thick part 161 and with a bottom end formed into a substantially semispherical shape—all integrally formed. The ring-shaped rib 164 provided at the outer peripheral edge of the first diaphragm 137 is engaged in the two ring-shaped recessed grooves 144, 151 provided at the body A122 and body B123 and is fastened by clamping between the body A122 and body B123. Further, the space formed between the inclined surface of the valve element 165 and the peripheral edge of the bottom end face of the opening 148 of the body B123 forms the fluid control part 168.

138 is a PTFE second diaphragm. At its center, it has a cylindrical thick part 169, a circular shaped thin film part 170 provided extending from the bottom end face of the thick part 169 in the radial direction, and a ring-shaped seal part 171 provided at the outer peripheral edge of the thin film part 170 all integrally formed. Further, the ring-shaped seal part 171 of the peripheral edge of the thin film part 170 is fastened by being clamped by the top step 146 of the body B123 and the ring-shaped projection 155 of the body C124. Note that the pressure receiving area of the second diaphragm 138 has to be set smaller than that of the first diaphragm 137.

139 is a PTFE third diaphragm. It is shaped the same as the second diaphragm 138 but is arranged upside down. The top end face of the thick part 172 contacts the bottom rod 167 of the valve member 136. Further, the ring-shaped seal part 174 of the peripheral edge of the thin film part 173 is fastened clamped between the bottom step 143 of the body A122 and the ring-shaped projection 159 of the body E126. Note that the pressure receiving area of the third diaphragm 139 also has to be set smaller than that of the first diaphragm 137 in the same way as above.

140 is a fourth diaphragm. At its peripheral edge, it has a cylindrical rib 175 with an outside diameter substantially the same in diameter as the diaphragm chamber 153 of the body C124 and, at its center, a cylindrical part 176 and a film part 177 provided connecting the inner circumference of the bottom end face of the cylindrical rib 175 and the outer circumference of the top end face of the cylindrical part 176. The cylindrical rib 175 is fastened by engagement with the diaphragm chamber 153 of the body C124 and is fastened by clamping between the body B123 and body C124, while the cylindrical part 176 is designed to be able to move up and down in the diaphragm chamber 153. Further, the bottom of the cylindrical part 176 is engaged with the thick part 169 of the second diaphragm 138.

178 and 179 are a PVDF spring holder and SUS spring provided in the opening 158 of the body E126. The two apply pressure to the third diaphragm 139 in the inward direction (upward direction in the figure).

Due to the above explained configuration, it is learned that the chamber 127 formed inside the body 121 is divided into the first pressurized chamber 128 formed from the fourth diaphragm 140 and air chamber 156 of the body D125, the second valve chamber 129 comprised of the bottom second valve chamber 132 formed between the first diaphragm 137 and bottom step 149 of the body B123 and the top second valve chamber 133 formed from the second diaphragm 138 and opening 147 of the body B123, the first valve chamber 130 comprised of the bottom first valve chamber 134 formed by the third diaphragm 139 and the opening 142 of the body A122 and the top first valve chamber 135 formed by the first diaphragm 137 and the step 141 of the body A122, and the second pressurized chamber 131 formed by the third diaphragm 139 and the opening 158 of the body E126.

Next, the operation of the 10th embodiment of the present invention will be explained.

Here, the operation of a fluid control valve 4a with respect to operating pressure supplied from the electro-pneumatic converter (not shown) is as follows. The fluid flowing from the inlet channel 145 of the body A122 of the fluid control valve 4a to the first valve chamber 130 is reduced in pressure by passing through the communication hole 146 of the valve member 136 and flows into the bottom second valve chamber 132. Further, when the fluid flows from the bottom second valve chamber 132 through the fluid control part 168 to the top second valve chamber 133, it is again reduced in pressure by the pressure loss at the fluid control part 168 and flows out from the outlet channel 152. Here, the diameter of the communication hole 162 is set sufficiently small, so the flow rate through the valve is determined by the pressure difference before and after the communication hole 162.

At this time, if viewing the forces received by the diaphragms 137, 138, 139 from the fluids, the first diaphragm 137 receives an upward direction force due to the difference in fluid pressures between the first valve chamber 130 and bottom second valve chamber 132, the second diaphragm 138 receives the upward direction force due to the fluid pressure of the top second valve chamber 133, and the third diaphragm 139 receives the downward direction force due to the fluid pressure of the first valve chamber 130. Here, the pressure receiving area of the first diaphragm 137 is set sufficiently larger than the pressure receiving areas of the second diaphragm 138 and third diaphragm 139, so the forces acting on the second and third diaphragms 138, 139 can be almost completely ignored compared with the force acting on the first diaphragm 137. Therefore, the force received by the valve member 136 from the fluid becomes the upward direction force due to the difference in fluid pressures between the first valve chamber 130 and bottom second valve chamber 132.

Further, the valve member 136 is biased downward by the pressurizing means of the first pressurized chamber 128. At the same time, it is biased upward by the pressurizing means of the second pressurized chamber 131. If adjusting the force of the pressurizing means of the first pressurized chamber 128 to be larger than the force of the pressurizing means of the second pressurized chamber 131, the composite force received by the valve member 136 from the pressurizing means becomes a downward direction force. Here, the “pressurizing means of the first pressurized chamber 128” uses the operating pressure supplied from the electro-pneumatic converter, while the “pressurizing means of the second pressurized chamber 131” uses the springback force of the spring 179.

Therefore, the valve member 136 stabilizes at the position where the downward direction composite force of the pressurizing means and the upward direction force due to the difference in fluid pressures of the first valve chamber 130 and bottom second valve chamber 132 balance. That is, the pressure of the bottom second valve chamber 132 is automatically adjusted by the opening area of the fluid control part 168 so that the composite force due to the pressurizing means and the force due to the difference in fluid pressures balance. For this reason, the difference in fluid pressures between the first valve chamber 130 and bottom second valve chamber 132 becomes constant and the differential pressure before and after the communication hole 162 is held constant, whereby the flow rate of the flow through the valve is kept constant at all times.

Here, each fluid control valve 4a acts so that the composite force of the pressurizing means acting on the valve member 136 and the force due to the pressure difference between the first valve chamber 130 and bottom second valve chamber 132 balance, so if adjusting and changing the composite force of the pressurizing means acting on the valve member 136, the difference in fluid pressures of the first valve chamber 130 and bottom second valve chamber 132 becomes a corresponding value. That is, by adjusting the downward direction force due to the pressurizing means of the first pressurized chamber, that is, the operating pressure supplied from the electro-pneumatic converter, it is possible to change the pressure difference before and after the communication hole 162, so it is possible to set the flow rate to any flow rate without disassembling the valve.

Further, by adjusting the force due to the pressurizing means of the first pressurized chamber 128 to become smaller than the force due to the pressurizing means due to the second pressurized chamber 131, the composite force acting on the valve member 136 becomes just in the upward direction, the valve element 165 of the valve member 136 is pushed against the valve seat 150 of the opening 148 of the valve element 165, and the fluid can be cut off. That is, if adjusting the electro-pneumatic converter to not apply any operating pressure, the fluid control valve 4a is closed.

Due to this, by using a fluid control valve 4a, the fluid flowing through the feed line of the fluid mixing system is controlled to become constant in flow rate. Further, even if the upstream side pressure or downstream side pressure of the fluid flowing into the feed line fluctuates, the first fluid control valve 4a operates to hold the flow rate constant automatically, so even if pump pulsation or other instantaneous pressure fluctuations occur, stable control of the flow rate is possible. Further, the fluid control valve 4a is configured to not be affected by fluctuations in the back pressure, so this can be preferably used for applications where the back pressure fluctuates. Further, by adjusting the operating pressure, the fluid control valve 4a can also be used as a shutoff valve.

### 11th Embodiment)

Next, a fluid mixing system of an 11th embodiment of the present invention will be explained based on FIG. 24. Here, the case where the flow rate measuring devices 3, 9 of the first embodiment are replaced by the flow rate measuring devices 3a of the present embodiment consisting of ultrasonic flow meters will be explained.

3a is a flow rate measuring device for measuring the flow rate of a fluid. Each flow rate measuring device 3a has an inlet channel 381, a first rising channel 382 provided perpendicularly from the inlet channel 381, a straight channel 383 communicating with the first rising channel 382 and provided substantially parallel to the axis of the inlet channel 381, a second rising channel 384 provided perpendicularly from the straight channel 383, and an outlet channel 385 communicating with the second rising channel 384 and provided substantially parallel to the axis of the inlet channel 381. The first and second rising channels 382, 384 are provided at their side walls with ultrasonic vibrators 386, 387 facing each other at positions intersecting the axis of the straight channel 383. The ultrasonic vibrators 386, 387 are covered by a fluororesin. Wires extending from the vibrators 386, 387 are connected to a processing unit (not shown) of a control unit (not shown). Note that the parts of the flow rate measuring device 3a other than the ultrasonic vibrators 386, 387 are made of PFA.

Next, the operation of the 11th embodiment of the present invention will be explained.

The fluid flowing into the fluid measuring device 3a is measured for flow rate in the straight channel 383. Ultrasonic vibration is propagated through the flow of the fluid from the ultrasonic vibrator 386 positioned at the upstream side to the ultrasonic vibrator 387 positioned at the downstream side. The ultrasonic vibration received by the ultrasonic vibrator 387 is converted into an electrical signal and output to the processing unit (not shown) of the control unit (not shown). When ultrasonic vibration is propagated from the upstream side ultrasonic vibrator 386 to the downstream side ultrasonic vibrator 387 for reception, transmission/reception is instantaneously switched in the processing unit, the ultrasonic vibration is propagated from the ultrasonic vibrator 387 positioned at the downstream side to the ultrasonic vibrator 386 positioned at the upstream side. The ultrasonic vibration received by the ultrasonic vibrator 386 is converted to an electrical signal which is then output to the processing unit in the control unit. At this time, the ultrasonic vibration is propagated against the flow of fluid in the straight channel 383, so compared with the propagation of ultrasonic vibration from the upstream side to the downstream side, the propagation speed of the ultrasonic vibration in the fluid is slower and the propagation time is longer. The output electrical signals are used in the processing unit to calculate the propagation time. The flow rate is calculated from the difference in propagation times. The flow rate calculated at the processing unit is converted to an electrical signal and output to a controller (not shown).

Due to this, the flow rate measuring device 3a, comprised of the ultrasonic flow meter, measures the flow rate from the difference of propagation times in the direction of flow of the fluid, so can accurately measure even fine flow rates.

### 12th Embodiment

Next, a 12th embodiment of the present invention will be explained based on FIG. 325. Here, the case where the flow rate measuring devices 3, 9 of the first embodiment are replaced by flow rate measuring devices 3b of the present embodiment consisting of ultrasonic type vortex flow meters will be explained.

3b is a flow rate measuring device for measuring the flow rate of a fluid. The flow rate measuring device 3b has an inlet channel 391, a vortex generator 392 suspended down into the inlet channel 391 and generating a Karman vortex, and an outlet channel 393 provided in a straight channel 394. At the side walls of the straight channel 394 at the downstream side of the vortex generator 392, ultrasonic vibrators 395, 396 are arranged facing each other at positions perpendicularly intersecting the channel axis direction. The ultrasonic vibrators 395, 396 are covered by a fluororesin. The wires extending from the vibrators 395, 396 are connected to a processing unit (not shown) of a control unit (not shown). The parts of the flow rate measuring device 3b other than the ultrasonic vibrators 395, 396 are made of PTFE.

Next, the operation of the 12th embodiment of the present invention will be explained.

The fluid flowing into the fluid measuring device 3b is measured for flow rate at the straight channel 394. Ultrasonic vibration is propagated in the fluid flowing through the straight channel 394 from the ultrasonic vibrator 395 toward the ultrasonic vibrator 396. The Karman vortex generated downstream of the vortex generator 392 is generated by a cycle proportional to the flow rate of the fluid. Karman vortexes with different vortex directions are alternately generated, so the ultrasonic vibration is accelerated or decelerated in the direction of progression when passing through the Karman vortexes depending on the vortex direction of the Karman vortexes. For this reason, the ultrasonic vibration received by the ultrasonic vibrator 396 fluctuates in frequency (period) due to the Karman vortexes. The ultrasonic vibrations transmitted and received by the ultrasonic vibrators 395, 396 are converted to electrical signals which are then output to a processing unit (not shown) of a control unit (not shown). The processing unit calculates the flow rate of the fluid flowing through the straight channel 394 based on the frequency of the Karman vortexes obtained from the phase difference between the ultrasonic vibration output from the transmitting side ultrasonic vibrator 395 and the ultrasonic vibration output from the receiving side ultrasonic vibrator 396. The flow rate calculated by the processing unit is converted to an electrical signal and output to a control unit (not shown).

Due to this, the ultrasonic type vortex flow meter can accurately measure the flow rate even when the flow rate is large since the larger the flow rate, the more the Karman vortexes are generated and therefore a superior effect is exhibited in large flow rate fluid control.

Due to the operation of the 11th embodiment and 12th embodiment, the ultrasonic type vortex flow meters can accurately measure the flow rates even when the flow rates are large since the larger the flow rates, the more the Karman vortexes are generated and therefore superior effects are exhibited in large flow rate fluid control.

### 13th Embodiment)

Next, a 13th embodiment of the present invention having three feed lines will be explained.

The fluid mixing system of the present embodiment is configured like in the third embodiment but provided with a third feed line of a configuration similar to the first and second feed lines and having a header of the feed lines at the downstream-most side of the feed lines (not shown). The feed lines are configured in the same way as in the third embodiment, so explanations are omitted.

Next, the operation of the 13th embodiment of the present invention will be explained.

Here, the first feed line is charged with pure water, the second feed line is charged with hydrogen peroxide, and the third feed line is charged with ammonia water to mix them to give a ratio of pure water, hydrogen peroxide, and ammonia water of 50:2:1. The pure water flowing in the first feed line is controlled in flow rate in the first feed line, the hydrogen peroxide flowing in second feed line is controlled in flow rate in the second feed line, the ammonia water flowing in the third feed line is controlled in flow rate in the third feed line, the fluids merge at the header and are mixed by the set ratio (ratio of flow rates of first feed line, second feed line, and third feed line of 50:2:1), and a mixed fluid (ammonia-hydrogen peroxide) flows out at the set flow rate.

Similarly, in this embodiment, even if charging the third feed line not with ammonia water, but with hydrochloric acid and mixing the fluids to give a ratio of pure water, hydrogen peroxide, and hydrochloric acid of 20:1:1, the fluids are mixed at the set ratio and a mixed fluid (hydrochloric acid-hydrogen peroxide) flows out at the set flow rate.

The outflowing mixed fluids (ammonia-hydrogen peroxide and hydrochloric acid-hydrogen peroxide) are used in treatment steps of a substrate washing apparatus. In the washing apparatus, first, the substrates are treated by the ammonia-hydrogen peroxide to remove foreign matter, then are rinsed by pure water, next the substrates are treated by the hydrochloric acid-hydrogen peroxide to remove metals, then are rinsed by pure water, then the substrates are treated by dilute fluoric acid (mixed fluid described in first embodiment) to remove the oxide films, then are rinsed by pure water and finally the substrates are dried. At this time, by introducing the mixed fluids obtained by the fluid mixing system of the present invention into the washing tanks as the chemicals of these different steps, it is possible to feed these chemicals at continuously constant mixing ratios and stably wash the substrates.

### 14th Embodiment

Next, an 14th embodiment of the present invention having three feed lines will be explained.

The structure of the fluid mixing system of the present embodiment is similar to that of the 13th embodiment, so the explanation will be omitted. Next, the operation of the 14th embodiment of the present invention will be explained.

Here, the first feed line is charged with pure water, the second feed line is charged with ammonium fluoride, the third feed line is charged with hydrofluoric acid, and the fluids are mixed to give a ratio of pure water, ammonium fluoride, and hydrofluoric acid of 50:2:1. The pure water flowing in the first feed line is controlled in flow rate in the first feed line, the ammonium fluoride flowing in the second feed line is controlled in flow rate in the second feed line, the hydrofluoric acid flowing in the third feed line is controlled in flow rate in the third feed line, the fluids merge at the header and are mixed by the set ratio (ratio of flow rates of first feed line, second feed line, and third feed line of 50:2:1), and a mixed fluid flows out at the set flow rate. The outflowing mixed fluid is used in the treatment steps of an etching apparatus for substrates. In the etching apparatus, the mixed fluid is used to etch the oxide films of the substrates.

The mixed fluids obtained by mixing the fluids by the ratios of the first, fourth, fifth, sixth, 17th, and 18th embodiments of the present invention are suitably used as chemicals for the surface treatment of substrates in the front-end steps of semiconductor production processes. If the fluids and mixing ratios are in the scope of the present invention, mixed fluids suitable for different processing in the front-end steps of semiconductor production processes can be obtained.

Note that the present invention was explained in detail based on specific embodiments, but a person skilled in the art could make various changes, modifications, etc. to them without departing from the claims and ideas of the present invention.

1-17. (canceled)

18. A fluid mixing system mixing fluids flowing through at least two feed lines by any ratio, wherein each of the feed lines comprises
a fluid control valve controlling a pressure of a fluid by a pressure operation of a control fluid,
a flow rate measuring sensor sensing a physical parameter from which a flow rate of the fluid can be calculated, converting the physical parameter to an electrical signal, and outputting the same,
a control unit outputting a command signal for controlling the opening area of the fluid control valve to the fluid control valve or equipment operating the fluid control valve based on the error between the calculated value of the flow rate and a flow rate setting,
a shutoff valve for opening up or cutting off the flow of fluid, such that one of the at least two feed lines comprises a first shutoff valve and the other of the at least two feed lines comprises a second shutoff valve, and
a throttle valve able to adjust the opening area, and wherein
the first shutoff valve is at an upstream-most side of the one feed line and the second shutoff valve is at a upstream-most side of the other of the feed lines, and
the fluid mixing system further comprises a header of the feed lines provided at the downstream-most sides of the feed lines, and
a flushing system in which an upstream side of the first shutoff valve and a downstream side of the second shutoff valve are communicated through a third shutoff valve.

19. A fluid mixing system as set forth in claim 18, wherein the header is a manifold valve making the feed lines merge into a single channel.

20. A fluid mixing system as set forth in claim 18, wherein the various valves and the flow rate measuring device are directly connected without using any independent connecting means.

21. A fluid mixing system as set forth in claim 18, wherein the various valves and the flow rate measuring device are provided on a single base block.

22. A fluid mixing system as set forth in claim 18, wherein the various valves and the flow rate measuring device are provided housed in a single casing.

23. A fluid mixing system as set forth in claim 18, wherein each fluid control valve comprises
a body having a second cavity provided at its bottom center opening to the bottom, an inlet channel communicated with the second cavity, a first cavity provided at its top opened to the top surface and having a diameter larger than the diameter of the second cavity, an outlet channel communicated with the first cavity, and a communication hole communicating the first cavity and second cavity and having a smaller diameter than the diameter of the first cavity, the top surface of the second cavity made the valve seat;
a bonnet having inside it a cylindrical cavity communicating with an air feed hole and exhaust hole provided at the side surface or top surface and provided with a step at the inner circumference of its bottom end;
a spring holder inserted into the step of the bonnet and having a through hole at its center;
a piston having a first connector of a diameter smaller than the through hole of the spring holder at its bottom end, provided with a flange at its top, and inserted into the cavity of the bonnet to be able to move up and down;
a spring supported clamped between the bottom end face of the flange of the piston and the top end face of the spring holder;
a first valve mechanism having a first diaphragm with a peripheral edge fastened clamped between the body and the spring holder and with a thick center forming a first valve chamber in a manner capping the first cavity of the body, a second connector at the center of the top surface fastened joined to the first connector of the piston through the through hole of the spring holder, and a third connector at the center of the bottom surface passing through the communication hole of the body;
a second valve mechanism having a valve element positioned inside the second cavity of the body and provided in a larger diameter than the communication hole of the body, a fourth connector provided projecting out from the top end face of the valve element and fastened joined to the third connector of the first valve mechanism, a rod provided projecting out from the bottom end face of the valve element, and a second diaphragm provided extending out from the bottom end face of the rod in the radial direction; and
a base plate positioned below the body, having at the center of its top a projection for fastening the peripheral edge of the second diaphragm of the second valve mechanism by clamping it with the body, provided with an inset recess at the top end of the projection, and provided with a breathing hole communicating with the inset recess;
the opening area of the fluid control part formed by the valve element of the second valve mechanism and the valve seat of the body changing along with up and down movement of the piston.

24. A fluid mixing system as set forth in claim 18, wherein each fluid control valve has a body formed from an inlet channel and outlet channel of the fluid and a chamber communicating the inlet channel and outlet channel, a valve member having a valve element and first diaphragm, and a second diaphragm and third diaphragm positioned at the bottom and top of the valve member and having an effective pressure receiving area smaller than the first diaphragm; the valve member and the diaphragms are attached in the chamber by the outer circumferences of the diaphragms being fastened to the body; the diaphragms divide the chamber into a first pressurized chamber, second valve chamber, first valve chamber, and second pressurized chamber; the first pressurized chamber has a means for applying a certain force in an inward direction to the second diaphragm at all times; the first valve chamber is communicated with the inlet channel; the second valve chamber has a fluid control part having a valve seat corresponding to the valve element of the valve member, formed divided into a bottom second valve chamber positioned at the first diaphragm side from the valve seat and communicated with the first valve chamber by a communication hole provided in the first diaphragm and a top second valve chamber positioned at the second diaphragm side and communicated with the outlet channel, and changing in opening area between the valve element and valve seat by up and down movement of the valve member to control the fluid pressure of the bottom second valve chamber; and the second pressurized chamber has a means for applying a certain force in the inward direction to the third diaphragm at all times.

25. A fluid mixing system as set forth in claim 18, wherein said throttle valve comprises
a body formed with a valve seat surface at the bottom surface of the valve chamber provided at the top and having an inlet channel communicating with a communication port provided at the center of the valve seat surface and an outlet channel communicating with the valve chamber;
a diaphragm integrally provided with a first valve element able to be inserted into the communication port by advancing and retracting movement in the axial direction of the stem and projecting hanging down from the center of the liquid contacting surface, ring-shaped projecting second valve element able to approach and separate from the valve seat surface and formed at a position away from the first valve element in the radial direction, and a thin film part formed continuing in the radial direction from the second valve element;
a first stem having a handle fastened to its top and having a female thread at its bottom inner circumference and a male thread having a pitch larger than the pitch of the female thread at its outer circumference;
a first stem support having a female thread screwed with the male thread of the first stem at its inner circumference;
a second stem having a male thread screwed with the female thread of the first stem at the outer circumference of its top and connected to the diaphragm at its bottom end;
a diaphragm holder positioned below the first stem support and supporting the second stem to be able to move up and down and rotate; and
a bonnet fastening the first stem and diaphragm holder.

26. A fluid mixing system as set forth in claim 18, wherein the flow rate measuring device is an ultrasonic flow meter, Karman vortex flow meter, ultrasonic vortex flow meter, bladed wheel flow meter, electromagnetic flow meter, differential pressure flow meter, volume flow meter, hot wire type flow meter, or mass flow meter.

27. A fluid mixing system as set forth in claim 18, wherein two types of fluid comprising hydrofluoric acid or hydrochloric acid and pure water are mixed in a ratio of hydrofluoric acid or hydrochloric acid and pure water of 1:10 to 200.

28. A fluid mixing system as set forth in claim 18, wherein three types of fluid comprised of ammonia water or hydrochloric acid, hydrogen peroxide, and pure water are mixed in a ratio of ammonia water or hydrochloric acid, hydrogen peroxide, and pure water of 1 to 3:1 to 5:10 to 200.

29. A fluid mixing system as set forth in claim 18, wherein three types of fluid comprised of hydrofluoric acid, ammonium fluoride, and pure water are mixed in a ratio of hydrofluoric acid, ammonium fluoride, and pure water of 1:7 to 10:50 to 100.
